(19) United States
(12) Patent Application Publication
(10) Pub. No.: US 2013/0135636 A1
(43) Pub. Date: May 30, 2013

(54) PRINTING APPARATUS AND MEASUREMENT APPARATUS

(71) Applicant: CANON KABUSHIKI KAISHA, Tokyo (JP)

(72) Inventors: Junya Kosuge, Kawasaki-shi (JP); Masaki Komatsu, Kawasaki-shi (JP); Kazuhiko Onuki, Tokyo (JP)

(73) Assignee: CANON KABUSHIKI KAISHA, Tokyo (JP)

(21) Appl. No.: 13/683,316

(22) Filed: Nov. 21, 2012

(30) Foreign Application Priority Data
Nov. 25, 2011 (JP) 2011-257085

(51) Int. Cl. G06K 15/02

(52) U.S. Cl. CPC G06K 15/027
USPC 358/1.9

(57) ABSTRACT

During a drying period for a sheet on which a color image for colorimetric measurement has been printed, or during a colorimetric measurement period, printing of a normal image for a different sheet can be concurrently performed. A printing apparatus includes: a printing unit, for printing an image on a sheet that is conveyed along a first path; a second path, to which the sheet can be moved from the first path, and along which the sheet printed by the printing unit is retained; and a colorimetric measurement unit, for performing colorimetric measurement of the color image printed on the sheet. While the sheet received in the second path is held before colorimetric measurement is performed, or while colorimetric measurement is performed by the colorimetric measurement unit, the first path can be employed to permit the printing unit to print an image on a different sheet.

### BACKGROUND OF THE INVENTION

1. Field of the Invention

The present invention relates to a printing apparatus that includes a colorimetric measurement function for images printed on a sheet, a colorimetric measurement apparatus and a printing method.

2. Description of the Related Art

For a printing apparatus that prints images by applying ink to a sheet, the densities of the images may vary depending on the sheet types and environmental conditions, such as the temperature and the humidity, even though the same ink is employed. A consistent print density is requested for printed products for commercial use, regardless of whether the printing of images is performed at different times.

In Japanese Patent Laid-Open No. 2008-281549, a method is disclosed whereby, before primary printing is performed to print desired normal images, color patches for colorimetric measurement are printed on a sheet, and based on colorimetric data obtained by measuring the colors of the color patches, calibration is performed during the primary printing. When this method is employed, during primary printing, images can be provided that have the same densities as those printed previously.

Before a colorimetric measurement is to be performed for a color patch, however, the patch color must be stabilized, and to accomplish this, the color patch must be sufficiently dried by natural drying for an extended period of time such as several to several tens of hours. During this sheet drying period a sheet is retained in the apparatus, and accordingly, a user must halt the printing process for the normal images.

### SUMMARY OF THE INVENTION

The present invention provides a printing apparatus wherein, during an extended drying period for a sheet on which a color image to be used for colorimetric measurement has been printed, or during a colorimetric measurement period, normal image printing can be performed for another sheet, and provide a printing method for the printing apparatus.

In the first aspect of the present invention, there is provided a printing apparatus comprising:

a first path;

a printing unit configured to print an image, including a color pattern for colorimetric measurement, on a sheet conveyed along the first path;

a second path configured to be able to receive the sheet from the first path, and to hold the sheet on which the image has been printed by the printing unit;

a colorimetric measurement unit configured to perform colorimetric measurement of the color pattern,

wherein (a) after a sheet with the color pattern is received in the second path and before the colorimetric measurement unit performs colorimetric measurement or (b) while the colorimetric measurement unit performs colorimetric measurement, the printing unit is able to print an image on a sheet other than the sheet with the color pattern.

In the second aspect of the present invention, there is provided a colorimetric measurement apparatus, incorporated in a printing apparatus that includes a printing unit that prints an image on a sheet being conveyed along a first path, the apparatus comprising:

a member serving as a second path, in which the sheet can be received from the first path and along which the sheet on which the image is printed by the printing unit is retained; and

a colorimetric measurement unit, for performing colorimetric measurement of the sheet,

wherein the member and the colorimetric measurement unit are integrally formed as a single unit, and the unit is detachably mounted on the printing apparatus.

In the third aspect of the present invention, there is provided a printing method, for an apparatus that includes a printing unit and a reading unit, comprising the steps of:

printing of an image on a first sheet by the printing unit;

after printing, holding the first sheet in a waiting state in the apparatus;

after waiting, reading of the image on the first sheet by the reading unit; and

while the first sheet is being held, or while the image is being read by the reading unit, conveying a second sheet, different from the first sheet, to the printing unit without interfering with the first sheet, and printing an image on the second sheet.

According to the present invention, in a state wherein, while undergoing drying, a sheet moved to the second path is retained there for an extended period of time, or in a state wherein a colorimetric measurement process is being performed, another sheet can be conveyed along the first path, and image printing of that sheet can be performed without either sheet interfering with the processing of the other. That is, normal image printing for which the performance of the colorimetric measurement is not required can be performed in parallel to the drying process and the colorimetric measurement process. Therefore, the user does not have to wait for a long time for the primary printing process to be permitted to begin, and thus, both the printing productivity and usability are greatly improved.

Further features of the present invention will become apparent from the following description of exemplary embodiments (with reference to the attached drawings).

### BRIEF DESCRIPTION OF THE DRAWINGS

FIG. 1 is a schematic diagram illustrating the general arrangement of a printing apparatus according to a first embodiment of the present invention;

FIG. 2 is an enlarged diagram illustrating a colorimetric measurement unit in FIG. 1;

FIG. 3 is a block diagram illustrating the arrangement of the control system of the printing apparatus in FIG. 1;

FIG. 4A is an explanatory diagram for a color patch printing operation performed by the printing apparatus in FIG. 1;

FIG. 4B is an explanatory diagram for the waiting state of a sheet on which color patches have been printed;

FIG. 5A is an explanatory diagram for the operation of the printing apparatus in FIG. 1 for performing a colorimetric measurement of the color patches;

FIG. 5B is an explanatory diagram for the operation for discharging the sheet on which the color patches have been printed;

FIG. 6A is an explanatory diagram for a color patch printing operation performed by a printing apparatus according to a second embodiment of the present invention;

FIG. 6B is an explanatory diagram for the waiting state of a sheet on which color patches have been printed;

FIG. 7A is an explanatory diagram for the operation of the printing apparatus of the second embodiment for performing a colorimetric measurement of the color patches;

FIG. 7B is an explanatory diagram for the operation for discharging the sheet on which the color patches have been printed;

FIG. 8 is an explanatory diagram for an example wherein a colorimetric measurement apparatus in FIG. 6A or 6B is located at a different position;

FIG. 9 is a schematic diagram illustrating the general arrangement of a printing apparatus according to a third embodiment of the present invention;

FIG. 10 is a perspective view of a colorimetric measurement unit in FIG. 9;

FIG. 11 is an explanatory diagram for the printing operation performed by the printing apparatus in FIG. 9;

FIG. 12A is an explanatory diagram showing a color patch printing operation performed by the printing apparatus in FIG. 9;

FIG. 12B is an explanatory diagram showing the state during which a color path bearing sheet is being dried;

FIG. 12C is an explanatory diagram showing the operation for performing the colorimetric measurement of the color patches;

FIG. 13 is a block diagram illustrating the arrangement of the control system of the printing apparatus in FIG. 9;

FIG. 14 is a flowchart for explaining the operation of the printing apparatus in FIG. 9;

FIG. 15 is a flowchart for explaining the operation of the printing apparatus in FIG. 9;

FIGS. 16A, 16B, 16C and 16D are explanatory diagrams showing different operations performed by a printing apparatus according to a fourth embodiment of the present invention;

FIGS. 17A, 17B, 17C and 17D are explanatory diagrams showing different operations performed by a printing apparatus according to a fifth embodiment of the present invention;

FIG. 18 is a perspective view of the general arrangement of a printing apparatus according to a sixth embodiment of the present invention;

FIG. 19 is an explanatory diagram for the essential portion of the printing apparatus in FIG. 18 that is employed to perform a printing operation;

FIG. 20 is an explanatory diagram for the essential portion of the printing apparatus in FIG. 18 that is employed to perform a sheet drying process;

FIG. 21 is an explanatory diagram for the essential portion of a printing apparatus, according to a seventh embodiment of the present invention, that is employed to perform a sheet drying process;

FIG. 22 is an explanatory diagram for the essential portion of a printing apparatus, according to an eighth embodiment of the present invention, that is employed to perform a sheet drying process;

FIG. 23 is an explanatory diagram for the essential portion of a printing apparatus, according to a ninth embodiment of the present invention, that is employed to perform a sheet drying process;

FIG. 24 is an explanatory diagram for the essential portion of a printing apparatus, according to a tenth embodiment of the present invention, that is employed to perform a sheet drying process;

FIG. 25 is an explanatory diagram for the essential portion of a printing apparatus, according to an eleventh embodiment of the present invention, that is employed to perform a sheet drying process;

FIG. 26 is an explanatory diagram for the essential portion of a printing apparatus, according to a twelfth embodiment of the present invention, that is employed to perform a sheet drying process;

FIG. 27 is an explanatory diagram for the essential portion of the printing apparatus in FIG. 26 that is employed to perform a sheet rewinding process;

FIG. 28 is an explanatory diagram showing the essential portion of the printing apparatus in FIG. 26 that performs the sheet drying process; and

FIG. 29 is an explanatory diagram showing the essential portion of a printing apparatus, according to a thirteenth embodiment of the present invention, that is employed to perform a sheet drying process.

### DESCRIPTION OF THE EMBODIMENTS

The preferred embodiments of the present invention will now be described in detail. A printing apparatus employed for each embodiment has a color calibration function, and includes a printing unit for printing an image on a sheet, and a colorimetric measurement unit for performing the colorimetric measurement of a sheet on which an image (a test pattern) used for color calibration is printed.

### First Embodiment

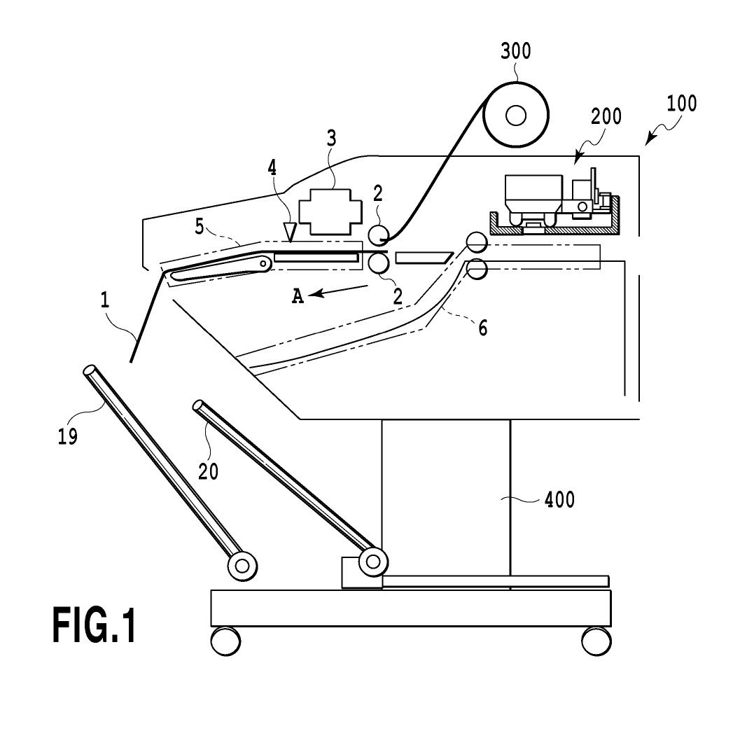

FIG. 1 is a schematic diagram illustrating the arrangement of a printing apparatus according to a first embodiment of the present invention. In the printing apparatus 100 of this embodiment, a long sheet 1, wound like a roll, is set in a sheet supply unit and conveyed by a conveying roller pair 2 in a direction indicated by an arrow A. In the description of this invention, the side on which a discharge portion is located, relative to an arbitrary position along a sheet conveyance path, is called the downstream side, and the opposite side is called the upstream side.

During the printing process performed for a normal image for which colorimetric measurement is not required, the sheet 1 is supplied from a sheet supply unit 300 and a desired image is printed thereon in a predesignated print position by the printing unit 3, and thereafter, a cutter 4 cuts the image bearing sheet portion off the sheet 1. Then, the portion cut off sheet 1 is passed along a printing conveyance path 5 and is discharged to a normal sheet basket (a first discharge portion) 19 attached to a stand 400. In this description, the path along which the sheet printed by the printing unit 3 is subsequently conveyed is called a first path.

In a case wherein colorimetric data is to be acquired, the sheet 1 supplied from the sheet supply unit 300 is conveyed along the first path, and a patch array P, consisting of color patches for colorimetric measurement, is printed in the print position by the printing unit 3. Thereafter, the portion of the sheet 1 whereon the color patches are printed is cut off the sheet 1 by the cutter 4, and as a separate cut sheet is passed along a colorimetry conveyance path 6, which is separated from the printing conveyance path 5, and is conveyed (fed back) to a colorimetric measurement unit 200 that is incorporated in the printing apparatus 100. There, the cut sheet is held by an edge that has been nipped by a roller pair, for an extended period of time, to permit the ink to dry before the colorimetric measurement process is begun. After the cut sheet has been held in this state, the cut sheet is again conveyed and the colorimetric measurement unit 200 performs colorimetric measurement for the patch array P. Thereafter, the cut sheet is conveyed along the colorimetry conveyance path 6, and is discharged to a colorimetry sheet basket (a second discharge portion) 20.

In the description for this invention, the colorimetry conveyance path 6 is called a second path. The colorimetry conveyance path 6 is formed of a horizontal first path segment 6a that passes a colorimetric measurement position, and a second path segment 6b that is located downstream of the first path segment 6a and is extended obliquely downward. The second path is provided so that the sheet can be moved from the first path to the second path, and a sheet printed by the printing unit 3 can be held along the second path before colorimetric measurement is to be performed.

The arrangement and the function of the printing apparatus 100 will now be described in detail.

The printing unit 3 is a unit that applies ink to the sheet 1 to print an image that includes a color patch, and, for example, an ink jet print head capable of ejecting ink can be employed as the printing unit 3. The ink jet print head employs ejection energy generation elements, such as electro-thermal converting elements (heaters) or piezoelectric elements for performing ink ejection. When the electro-thermal converting elements are employed, the electro-thermal converting elements generate heat to form ink bubbles, and by using the energy produced by the bubbles, ink is ejected through ejection ports formed at the distal ends of ink nozzles. Further, an arbitrary printing type is employed for the printing unit 3, and a so-called serial scan type or a full-line type may be employed. In the case of the serial scan type, conveying of a sheet in the sheet conveyance direction and scanning using the print head in the direction perpendicular to the sheet conveyance direction are repeated to print an image in the print position. In the case where full-line type is used, a long print head extended across the width of the sheet is employed, and while the conveying of the sheet is continuously performed, an image is printed in the print position. The printing apparatus 100 in this embodiment includes a serial scan type printing unit 3, and reciprocally moves, in a direction intersecting (in this embodiment, perpendicular to) the sheet conveyance direction, a carriage whereon a print head is mounted. The printing unit 3 can print a color image by using a plurality of ink colors. In this case, a patch array wherein square-block patches of individual ink colors are arranged is printed. The form of a color patch is not especially limited, and an arbitrary form can be employed.

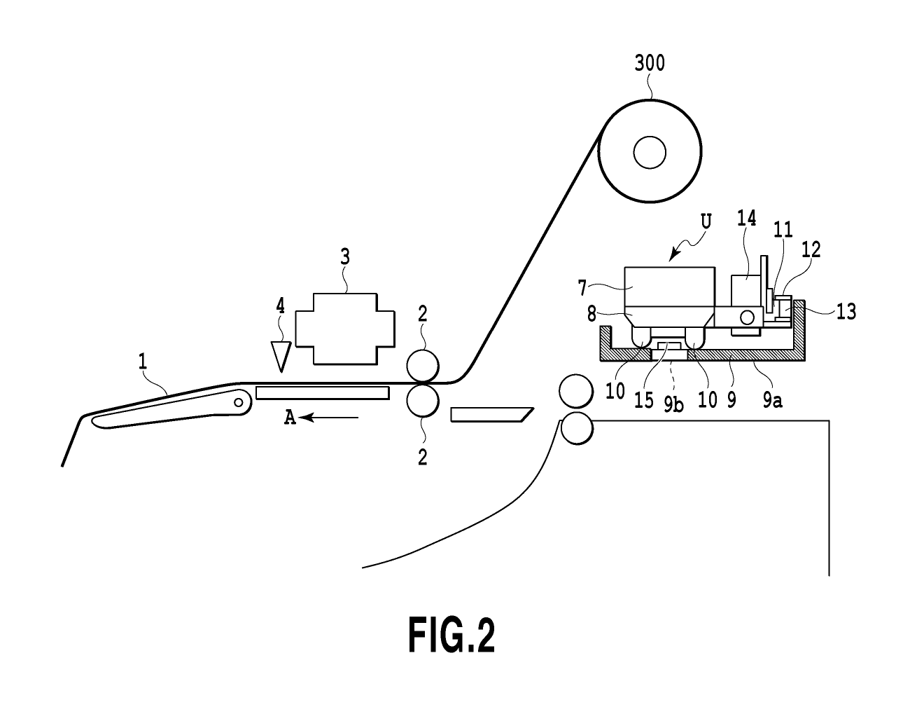

An example arrangement of the colorimetric measurement unit 200 will now be described by referring to FIG. 2. The calorimetric measurement unit 200 is a reading unit that includes a sensor for reading the colors of a color pattern (patch array) used to perform calibration. A colorimetric sensor 7 that performs quantitative measurement for the color of a patch array P is held by a sensor holder 8, which is supported by a support plate 9. A sliding member 10, arranged on the bottom face of the sensor holder 8, contacts the support plate 9. A loop-like belt 11 connected to the sensor holder 8 is extended between a motor pulley 12 and an idler pulley 13 that are located at a distance from each other in a direction perpendicular to the surface of the paper in FIG. 2. When the motor pulley 12 is rotated by a motor 14, the sensor holder 8 is moved via the belt 11 in the direction of the width of the sheet (the direction perpendicular to the surface of the paper in FIG. 2). During this movement, the accuracy of the posture of the colorimetric sensor 7 relative to a pressing face 9a of the support plate 9 is maintained through the support plate 9, the sliding member 10 and the sensor holder 8.

A color proof plate 15 is provided on the support plate 9, and the colorimetric sensor 7 scans above the support plate 9 in the widthwise direction of the sheet, and performs colorimetric measurements, through a slit 9b formed in the support plate 9, for color patches printed on the sheet 1. The color proof plate 15 is employed by the colorimetric sensor 7 for detecting the temporal change of colors, and during the colorimetric scanning period, the colorimetric sensor 7 frequently moves to a position opposite the color proof plate 15 and performs color proofing. The colorimetric sensor 7, the sensor holder 8, the support plate 9, the sliding member 10, the belt 11, the motor pulley 12, the idler pulley 13, the motor 14 and the color proof plate 15 constitute a unit that serves as a colorimetric measurement apparatus, and this unit is hereinafter called a colorimetric measurement unit U.

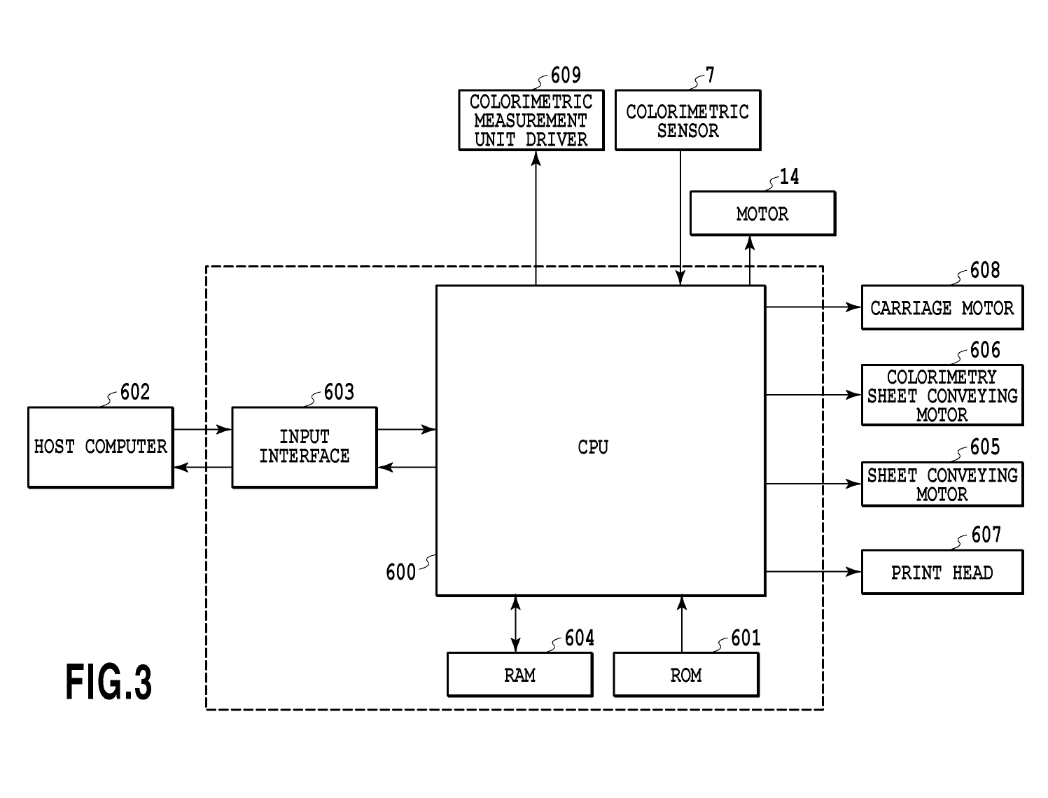

FIG. 3 is a block diagram illustrating the arrangement of the control system of the printing apparatus 100. A CPU 600 employs a control program stored in a ROM 601 and controls the entire operation performed by the printing apparatus 100, including printing, drying and colorimetric measuring. The CPU 600 receives, for example, print data and print mode setting information from a host computer 602 via an input interface 603. The CPU 600 stores the print data and the print mode setting information in a RAM 604, and reads these data from the RAM 604. The CPU 600 also controls a print head 607, a colorimetric measurement unit driver 609 and motors 605, 606. 608 and 14, based on the print data and the print mode setting information received from the host computer 602, and colorimetric data received from the colorimetric sensor 7. The colorimetric measurement unit driver 609 is a driver for elevating or lowering the colorimetric measurement unit U, as will be described later. The motor 605 is a sheet conveying motor that drives the conveying rollers 2 in FIG. 2, and the motor 606 is a colorimetry sheet conveying motor that drives a colorimetry conveying motor pair 18, as will also be described later. Further, the motor 608 is a motor that moves the carriage of the printing unit 3, and the motor 14 is a motor provided for the colorimetric measurement unit U, as shown in FIG. 2. When print data and print mode setting information are transmitted by the host computer 602 to the printing apparatus 100, the CPU 600 determines a printing control method to be used based on the print mode setting information, and begins printing.

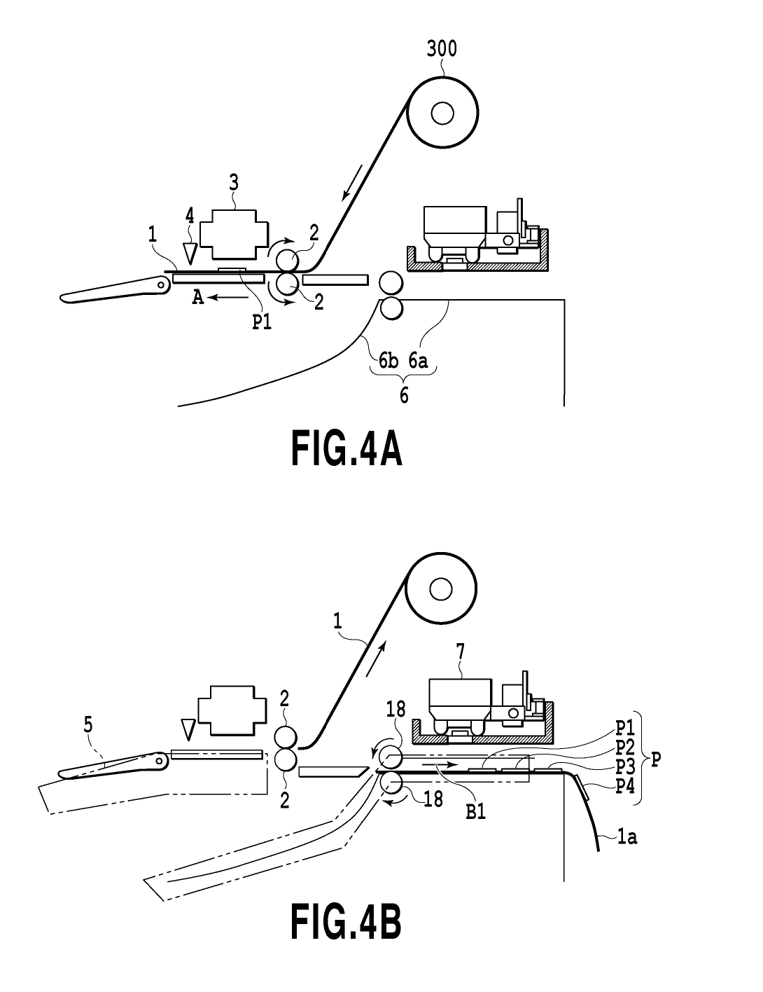

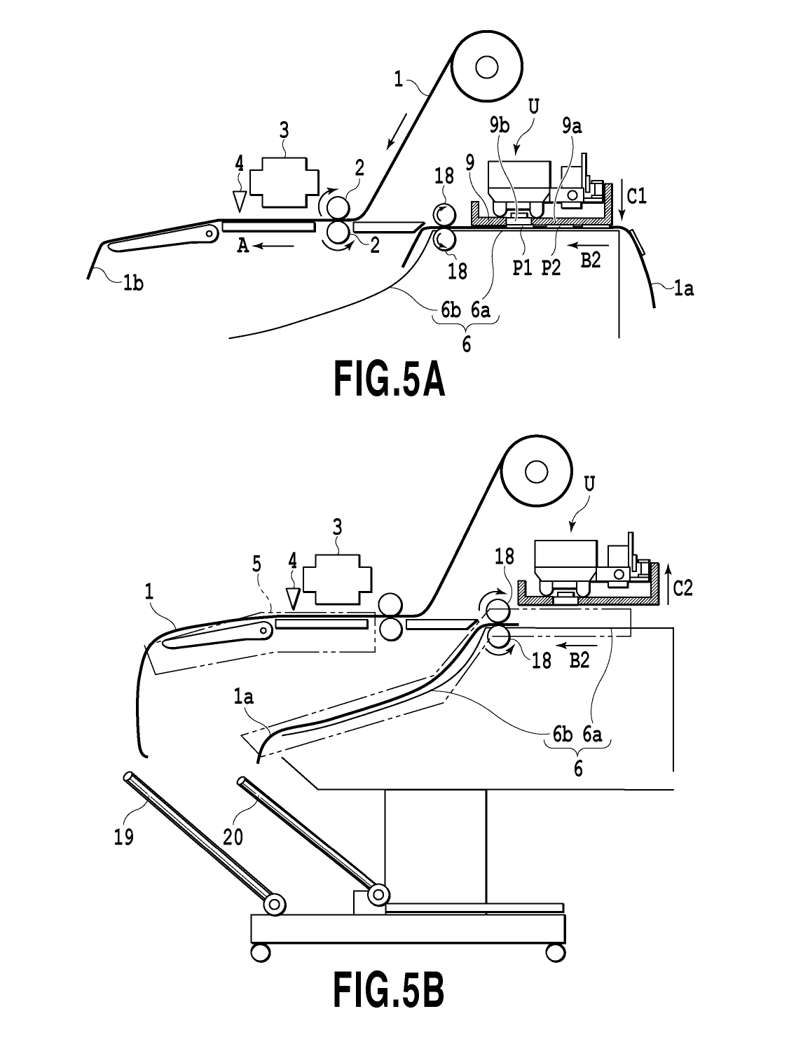

The processing sequences of printing, colorimetric measurement and discharging performed by the printing apparatus 100 will now be described based on FIGS. 4A, 4B, 5A and 5B.

To obtain colorimetric data, first, the sheet 1 is conveyed by the conveying roller pair 2 from the sheet supply unit 300 along the first path to the printing unit 3, as shown in FIG. 4A. While the sheet 1 is being intermittently conveyed by the conveying roller pair 2, a plurality of patch arrays P are printed by the print head 607 of the printing unit 3 as color patches used for colorimetric measurement, and thereafter, the printed portion of the sheet 1 is cut off by the cutter 4. In this embodiment, the plurality of patch arrays P, such as P1, P2 and P3, are printed.

Such a cut sheet 1a is conveyed (fed backward), in a direction indicated by an arrow B1, by the conveying roller pair 2 and the colorimetry conveying roller pair 18, and is moved from the first path to the colorimetry conveyance path 6 that is the second path. At this time, as shown in FIG. 4B, in accordance with the rotation of the conveying roller pair 2 and the rewinding of the sheet supply unit 300, the sheet 1, from which the sheet 1a was cut, is conveyed to a retracted position where the sheet 1 does not interfere with the sheet 1a.

When the sheet 1a has entered the first path segment 6a, as shown in FIG. 4B, and the patch arrays P have reached a point upstream of the colorimetric sensor 7 in the conveyance direction (to the right in FIG. 4B), the conveying of the sheet 1a is halted. The sheet 1a is then maintained at the position where the conveying was halted (a waiting position) for an extended period of time, until the patch arrays P have been natural-dried. In this state, the sheet 1a (first sheet) is located at the waiting position along the colorimetry conveyance path 6, i.e., at least one part of the sheet 1a is positioned along the second path while in the waiting state. In this situation, as shown in FIG. 5A, normal image printing for the sheet 1 (second sheet 2) can be concurrently performed by using the printing conveyance path 5. Further, when the colorimetric measurement unit begins the reading of the patch arrays, following the elapse of the waiting period, normal image printing can then be concurrently performed.

When ink on the sheet 1a has been appropriately natural-dried during the waiting period, the sheet 1a is conveyed by the colorimetry conveyance roller pair 18 in a direction indicated by an arrow B2, so that one of the patch arrays P on the sheet 1a reaches a position immediately below the slit 9b, which is the colorimetric measurement position. The calorimetric measurement unit U is then lowered, in a direction indicated by an arrow C1, by the driver 609, so as to press a pressing face 9a against the surface of the sheet 1a. When the sheet 1a is being so pressed, the colorimetric sensor 7 moves in the widthwise direction of the sheet 1a (the direction perpendicular to the surface of the paper of FIG. 5A) to perform the colorimetric measurement of the patch array P. In a case wherein a plurality of patch arrays P, such as P1, P2 and P3, have been printed, the releasing of the pressing face 9a from the sheet 1a, the conveying of the sheet 1a in the direction indicated by the arrow B2 and the pressing of the pressing face 9a against the sheet 1a are repeated to sequentially move the individual patch arrays P to the position whereat the colorimetric measurement is performed. For example, as shown in FIG. 5A, when colorimetric measurement has been performed for the patch array P1, the colorimetric measurement unit U is raised, in a direction indicated by the arrow C2 (see FIG. 5B), to remove the pressing face 9a from the sheet 1a, and thereafter, the sheet 1a is conveyed in the direction indicated by the arrow B2 to move the succeeding patch array P2 to the colorimetric measurement position. Then, the colorimetric measurement unit U is again lowered to press against the sheet 1a, and the colorimetric sensor 7 scans the sheet 1a to perform the colorimetric measurement of the patch array P2.

When the colorimetric measurement of the patch array P has been completed, as shown in FIG. 5B, the colorimetric measurement unit U is raised to release the sheet 1a, and the sheet 1a is conveyed, by the colorimetry conveying roller pair 18, along the second path segment 6b of the colorimetry conveyance path 6, and is discharged to the colorimetry sheet basket 20.

The sheet 1, for which the printing unit 3 performed the normal image printing concurrent with the waiting period or the colorimetric measurement period, is conveyed by the conveying roller pair 2 along the normal printing conveyance path 5, as shown in FIG. 5B, and the printed portion of the sheet 1 is cut off by the cutter 4. The cut sheet portion thus obtained is discharged as a sheet 1b (see FIG. 5A) to the normal image sheet basket 19.

According to this embodiment, the basic arrangement for the printing apparatus includes: the printing unit for printing an image on a sheet conveyed along the first path; the second path to which the sheet can be moved from the first path; and the colorimetric measurement unit for performing colorimetric measurement of the sheet on which an image has been printed. The second path is prepared in order to provide a location where a sheet printed by the printing unit can wait. As the characteristic element of this embodiment, in the state wherein the sheet moved to the second path is waiting for the colorimetric measurement of the sheet to be performed by the colorimetric measurement unit, or in the state wherein while colorimetric measurement of the sheet is being performed by the colorimetric measurement unit, image printing for another sheet can be performed by the printing unit using the first path. More specifically, the printing unit is arranged downstream of the colorimetric measurement unit, and when the sheet is being conveyed along the first path and an image used for colorimetric measurement is printed on the sheet by the printing unit, the sheet is then conveyed upstream and is transferred from the first path to the second path. When the waiting period has elapsed, the sheet held along the second path is conveyed downstream, and colorimetric measurement is performed for the sheet by the colorimetric measurement unit. According to the arrangement and the operation, the two sheets do not interfere with each other, and the printing of a normal image that does not require colorimetric measurement can be concurrently performed with the waiting period. Therefore, the user does not have to wait for an extended period of time for the start of the primary printing operation, and as a result, for printing, productivity and usability are greatly improved.

### Second Embodiment

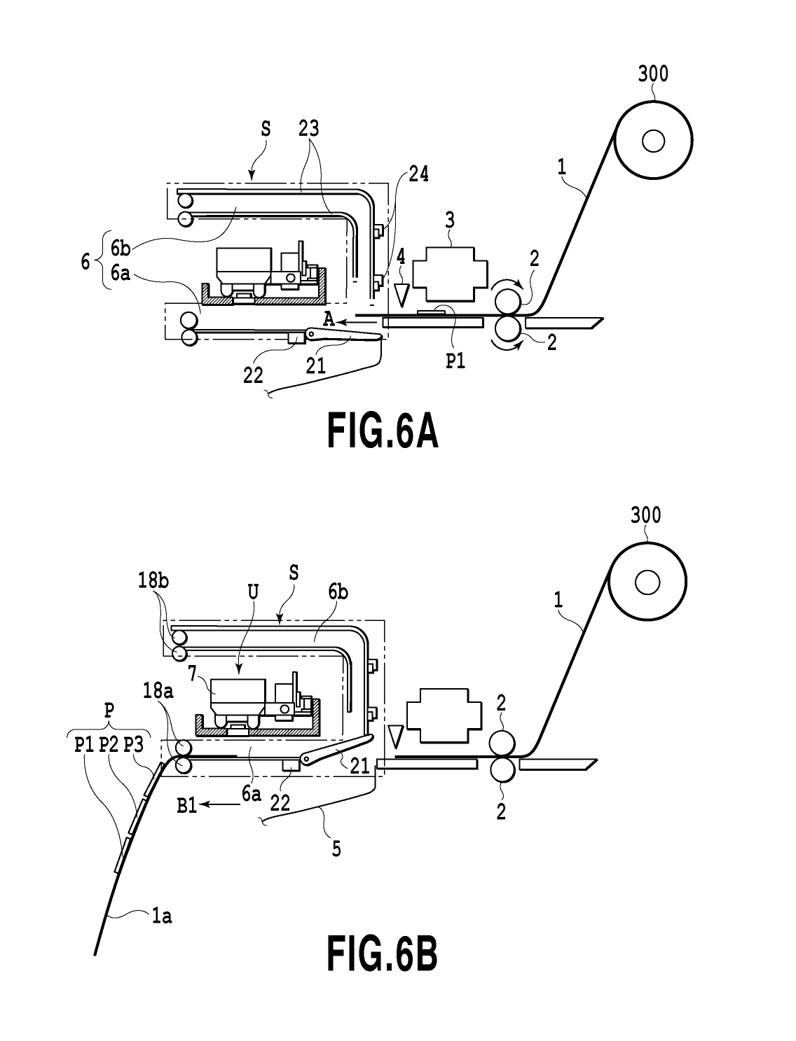

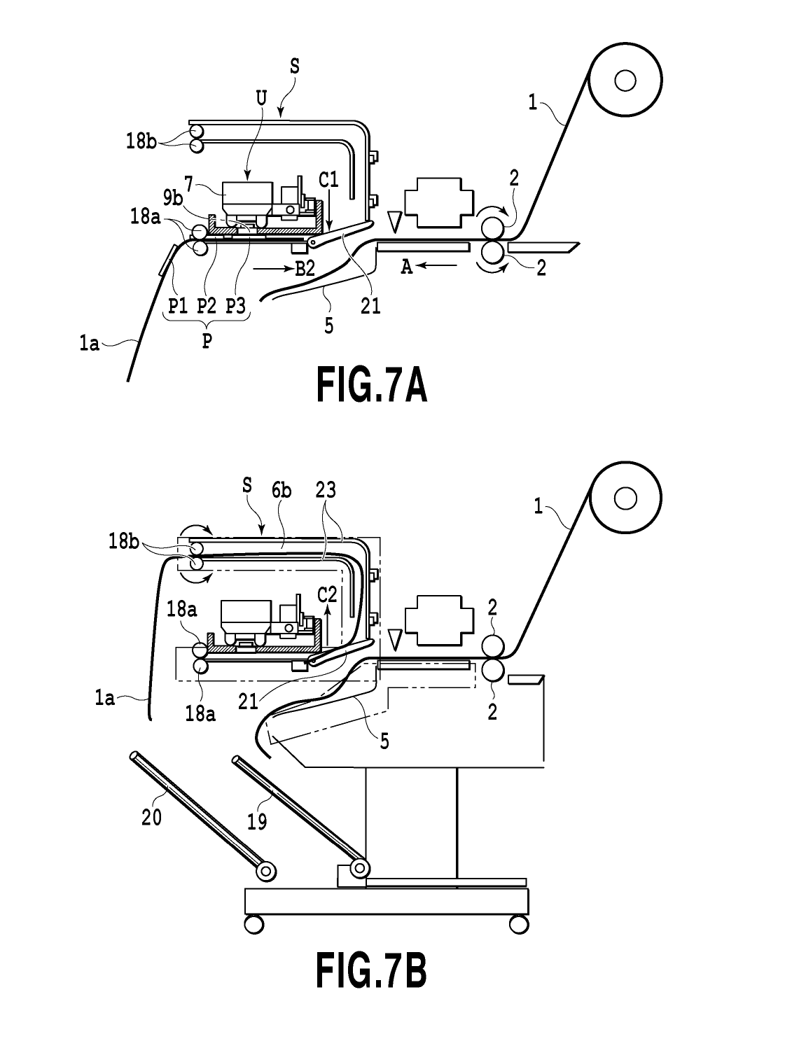

A second embodiment of the present invention will now be described based on FIGS. 6A, 6B, 7A and 7B. The same reference numerals as are used for the first embodiment are provided for corresponding or identical portions.

In this embodiment, members, such as colorimetry conveying roller pairs 18a and 18b, a branching unit 21 (switching means), a driver 22 and a discharge guide 23, are provided for a colorimetry conveyance path 6, and are integrally formed with a colorimetric measurement unit U to provide a combined unit. This colorimetric measurement apparatus provided as a combined unit is hereafter called a colorimetric measurement section S. The colorimetric measurement section S is detachably mounted on a printing apparatus 100 by using fixing members 24.

The first path is a path extending from a sheet supply unit 300, via a printing unit 3, to a cutter 4. A second path is a colorimetry conveyance path 6, and includes a horizontal first path segment 6a that passes through a colorimetry position opposite a colorimetric sensor 7 and a second path segment 6b that is connected to the first path segment 6a and extended obliquely downward.

To perform colorimetric measurement, first, as shown in FIG. 6A, a sheet 1 is conveyed by a conveying roller pair 2 from the sheet supply unit 300 along the first path to the printing unit 3. While the sheet 1 is being continuously conveyed by the conveying roller pair 1 in a direction indicated by an arrow A, a patch array P, used for colorimetric measurement, is printed by the printing unit 3. In this case, a plurality of patch arrays, such as P1, P2, . . . are printed. The portion of the sheet 1 on which the patch arrays P are printed is cut off by the cutter 4, and the sheet portion that has been cut off is defined as a sheet 1a. The sheet 1a is conveyed by the conveying roller pair 2 and the colorimetry conveying roller pair 18a in a direction indicated by an arrow B1, and is entered into the first path segment 6a of the colorimetry conveyance path 6. That is, the sheet 1a is moved from the first path to the second path. At this time, the branching unit 21 provided at the junction between the printing conveyance path 5 and the colorimetry conveyance path 6 is in the horizontal state, as shown in FIG. 6A where the second path is open, and the sheet 1a is guided along the branching unit 21 and enters the first path segment 6a.

Conveying of the sheet 1a in the first segment 6a is halted when, as shown in FIG. 6B, the patch arrays P have reached the position downstream of the colorimetric sensor 7 in the conveyance direction (to the left in FIG. 6B). Further, when the sheet 1a is conveyed downstream of the branching unit 21 in the conveyance direction, the branching unit 21 is rotated counterclockwise by a driver 22, and connects the first path segment 6a to the second path segment 6b, as shown in FIG. 6B. Then, until the patch arrays P have been air-dried, the sheet 1a is held at the waiting posture shown in FIG. 6B, where the right end is held by the colorimetry conveying roller pair 18a and the left end is dropped down by the weight of the sheet 1a.

In the state wherein the sheet 1 is waiting and the branching unit 21 closes the first path segment 6a, normal image printing for the sheet 1 can be concurrently performed by using the printing conveyance path 5, as shown in FIG. 7A. The branching unit 21 of in this embodiment is vertically pivoted to change the direction in which the sheet is to be passed.

After the patch arrays P on the sheet 1a have been dried, the sheet 1a is conveyed by the colorimetry conveying roller pair 18a in a direction indicated by an arrow B2, as shown in FIG. 7A, until one of the patch arrays P reaches the position immediately below a slit 9b, which is the colorimetric measurement position. Then, a colorimetric measurement unit U is lowered in a direction indicated by an arrow C1 to press a pressing face 9a against the surface of the sheet 1a, and in the pressure state, the colorimetric sensor 7 scans the sheet 1a in the widthwise direction to perform colorimetric measurement for the patch array P. In a case wherein a plurality of patch arrays P, such as P1, P2 and P3, are printed, releasing of the sheet 1a from the pressing face 9a, the conveying of the sheet 1a in the direction indicated by the arrow B2 and the pressing of the sheet 1a are repeated to sequentially move the individual patch arrays P in the order of P3, P2 and P1, and perform colorimetric measurement.

When colorimetric measurement for the patch arrays P has been completed, the colorimetric measurement unit U is raised in a direction indicated by C2 and releases the sheet 1a, and the sheet 1a is conveyed by the colorimetry conveying roller pairs 18a and 18b along the second path segment 6b of the colorimetry conveyance path 6, and is discharged to a colorimetry sheet basket 20.

The sheet 1, for which the printing unit 3 concurrently performed normal image printing with the waiting period or the colorimetric measurement process, is conveyed by the conveying roller pair 2 along the normal printing conveyance path 5, as shown in FIG. 7A, and the printed portion of the sheet 1 is cut off by the cutter 4. The cut portion of the sheet 1 is then discharged to a normal image sheet basket 19.

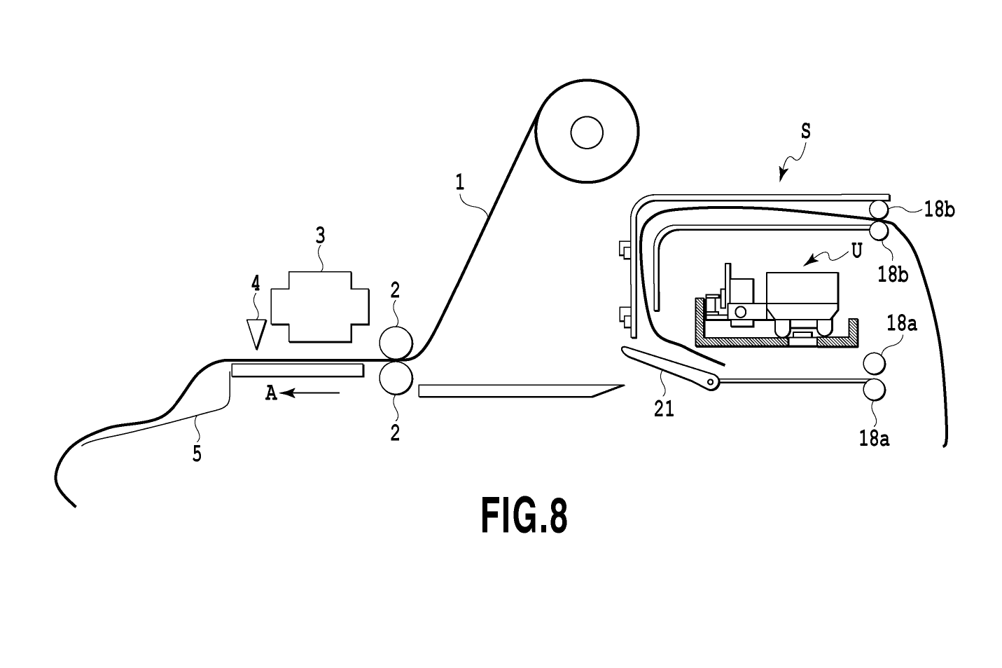

Since the colorimetric measurement section S, serving as a combined unit, is detachable from the printing apparatus 100, the colorimetric measurement section S may be removed from the printing apparatus 100 when colorimetric measurement is not required, so that the printing apparatus 100 can be employed as a common printer that does not incorporate a colorimetric measurement function. Therefore, the colorimetric measurement section S can be provided as an optional unit. Further, in this embodiment, the colorimetric measurement section S is arranged downstream of the printing unit 3 in the conveyance direction employed for printing (the direction indicated by the arrow A). However, as shown in FIG. 8, the colorimetric measurement unit S may be arranged upstream of the printing unit 3 in the conveyance direction employed for printing (the direction indicated by the arrow A).

In this embodiment, the printing unit is located upstream of the colorimetric measurement section, and when the sheet has been conveyed along the first path and an image used for colorimetric measurement has been printed on the sheet by the printing unit, the sheet is conveyed downstream and is moved from the first path to the second path. Then, following the elapse of the waiting period, the sheet held in the second path is conveyed upstream, and colorimetric measurement is performed for the sheet by the colorimetric measurement section. According to the arrangement and operation described above, the same operating effects as those obtained in the embodiment can be provided. Additionally, since the colorimetric measurement section is detachable from the printing apparatus, the colorimetric measurement section can be provided as an optional unit. Furthermore, for the maintenance for the colorimetric measurement section, the colorimetric measurement section need simply be removed from the printing apparatus, so that the ordinary printing operation is not interrupted, and the waiting period required for the maintenance of the colorimetric measurement section can be reduced.

### Third Embodiment

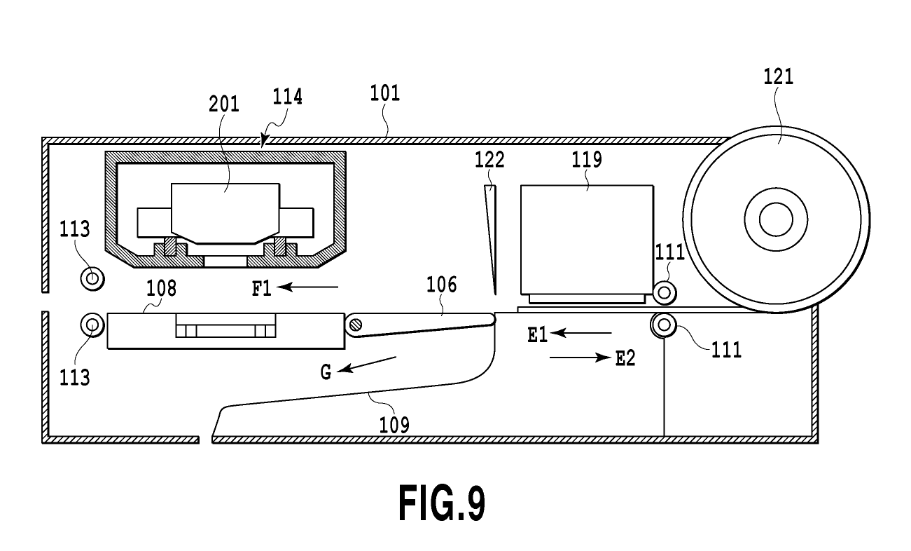

FIG. 9 is a schematic diagram illustrating the general structure of a printing apparatus according to a third embodiment of the present invention. In a printer main body 101, a sheet that is a printing medium is fed from a sheet supply unit 121 by an upstream conveying roller pair 111 in a direction indicated by an arrow E1. Color patches used for colorimetric measurement are printed on the sheet by a printing unit 119, and in accordance with the pivotal position of a branching unit 106 (switching means), the sheet is guided either to a colorimetry path 108, in a direction indicated by an arrow F1, or to a discharge path 109, in a direction indicated by an arrow G. The branching unit 106 in FIG. 9 is positioned to guide the sheet to the colorimetry path 108. The sheet guided along the colorimetry path 108 is dried while the sheet is supported by a holding roller pair 113, as will be described later, and thereafter, the sheet is again conveyed toward the printing unit 119, and colorimetric measurement of the color patches is performed by a colorimetric measurement unit 114. Following this, the sheet is guided by the branching unit 106 to the discharge path 109, in the direction indicated by the arrow G, and is discharged. In a case wherein a desired image other than a color patch used for colorimetric measurement is to be printed on the sheet, the image is printed on the sheet by the printing unit 119, and thereafter, as the branching unit 106 is pivoted, the image bearing sheet is guided to the discharge path 109, in the direction indicated by the arrow G, and is discharged.

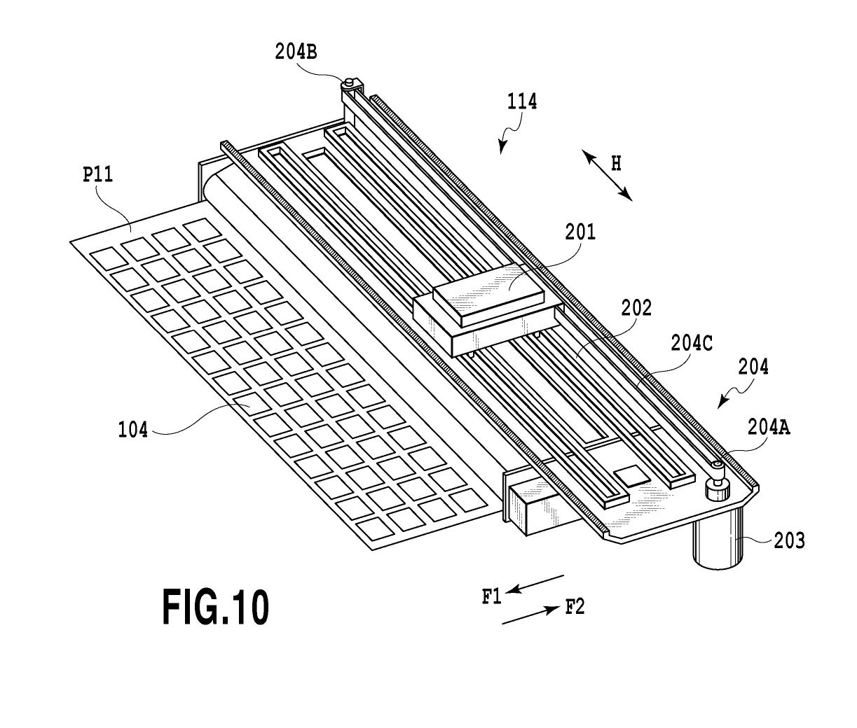

FIG. 10 is a perspective view for explaining an example structure of the colorimetric measurement unit 114. The colorimetric measurement unit 114 in this embodiment employs a colorimetric sensor 201 to read color data for color patches 104 that have been printed, for colorimetric measurement, on a sheet P11. Hereinafter, a sheet P11 on which color patches 104 are to be printed is also called a “colorimetry sheet”. The colorimetric sensor 201 reciprocates along rails 202, in directions, indicated by a double-headed arrow H, that intersect (in this embodiment, are perpendicular to) the directions in which the colorimetry sheet P11 is to be conveyed (directions indicated by arrows F1 and F2), and performs colorimetric measurement for the color patches 104. The colorimetric sensor 201 is moved by a driving force received from a colorimetric sensor driver 203 via a transmission unit 204. The transmission unit 204 in this embodiment includes a motor pulley 204A, which is to be rotated by the driver 203, and an idler pulley 204B, and a belt 204C that is mounted around these pulleys 204A and 204B to transmit a driving force to the colorimetric sensor 201. It should be noted that the structure shown in FIG. 10 is employed not only for the colorimetric measurement unit of this embodiment, but also for the other embodiments.

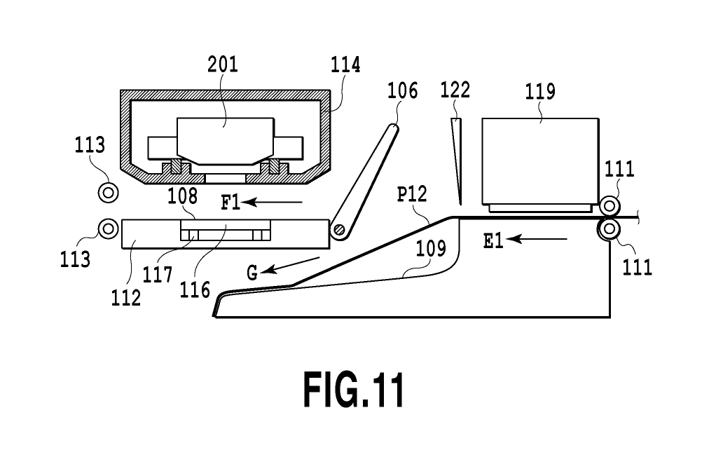

FIG. 11 is an explanatory diagram showing a conveyance path for a sheet P12 where an image, for which colorimetric measurement by the colorimetric measurement unit 114 is not performed, is printed. A sheet P12 for which colorimetric measurement is not performed is also called a “non-colorimetry sheet”. In a case wherein an image is printed on a non-colorimetry sheet P12, the branching unit 106 is pivoted upward, as shown in FIG. 11, by a driver 309, which will be described later, and a driving force transmission unit, so as to guide the non-colorimetry sheet P12 to the discharge path 109 in the direction indicated by the arrow G. Thereafter, an upstream conveying roller pair 111 is rotated by a driver 311, which will be described later, and a driving force transmission unit, and the non-colorimetry sheet P12 where an image that has been printed by the printing unit 119 is conveyed along the discharge path 109 and is discharged. Generally, as shown in FIG. 11, the branching unit 106 is located at the upward pivotal position and blocks the colorimetry path 108 to prevent ink mist generated during printing by the printing unit 119 from being attached to the colorimetric sensor 201 of the colorimetric measurement unit 114.

When the print head of the printing unit 119 is moved by the driver 308, which will be described later, and a driving force transmission unit in a direction that intersects (in this embodiment, is perpendicular to) the sheet conveyance direction, an image printing is performed for the sheet. The upstream conveying roller pair 111 is rotated by a driver 311, which will be described later, and a driving force transmission unit, and conveys the sheet. When the output direction of the driver 311 is changed, the sheet conveyance direction is switched between the direction, indicated by the arrow E1, toward the branching unit 106 and the direction, indicated by the arrow E2, toward the sheet supply unit 121.

In a case wherein the non-colorimetry sheet P12 conveyed along the discharge path 109 is a portion of a roll sheet (a continuous sheet), the roll sheet is conveyed until the printing edge of the non-colorimetry sheet P12, on which an image has been printed, reaches the position opposite a cutter 122, and when the roll sheet is cut at the printing edge by the cutter 122, the sheet P12 is discharged. The cutter 122 is driven by a driver 310, which will be described later, and a driving force transmission unit.

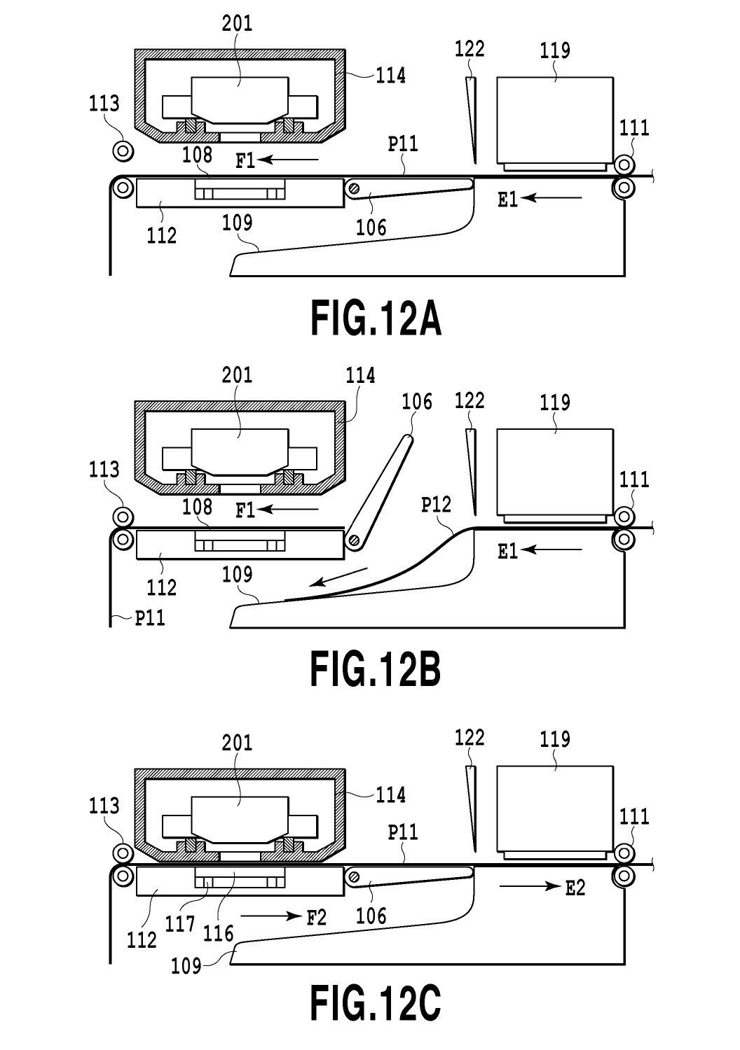

FIGS. 12A, 12B and 12C are explanatory diagrams for the colorimetric measurement processing performed by the colorimetric measurement unit 114.

First, as shown in FIG. 12A, the color patches 104 to be used for colorimetric measurement are printed, by the printing unit 119, on a sheet that is conveyed from the right in FIG. 12A along the first path, and the sheet is employed as a colorimetry sheet P11. The branching unit 106 is located at the position shown in FIG. 12A for guiding the colorimetry sheet P11 to the colorimetry path 108 in the direction indicated by an arrow F1. The colorimetry sheet P11 on which the color patches 104 have been printed by the printing unit 109 is conveyed by the upstream conveying roller pair 111 and is moved to the colorimetry path 108 (second path). At this time, the colorimetric measurement unit 114 is retracted to above the colorimetry path 108 by a driver 307, which will be described later, and a driving force transmission unit, so that the passage of the colorimetry sheet P11 will not be interrupted. The colorimetry sheet P11 is then passed between the colorimetric measurement unit 114 and a pressure plate unit 112.

Next, as shown in FIG. 12B, when the colorimetry sheet P11 on which the color patches 104 were printed has reached a predetermined position, the upper roller of a support roller pair 113 is lowered to hold the colorimetry sheet P11. The upper roller of the support roller pair 113 is moved up or down by a driver 312, which will be described later, and a driving force transmission unit. In a case wherein a long sheet, such as a roll sheet, is employed for the colorimetry sheet P11, the colorimetry sheet P11 is cut off by the cutter 122. After the colorimetry sheet P11 has been cut off, the sheet remaining on the side of the sheet supply unit 121 is rewound by a roll sheet rewinding device (not shown). Thereafter, the branching unit 106 is pivoted to form the discharge path 109, as shown in FIG. 12B.

As shown in FIG. 12B, the colorimetry sheet P11 is held by the support roller pair 113 until a predetermined drying period has elapsed to appropriately perform the natural-drying of the color patches 104 that were printed. That is, the colorimetry sheet P11 is sandwiched by the support roller pair 113 that is driven to be rotated, and is natural-dried while the colorimetry sheet P11 is supported in a suspended state. So long as one part of the sheet can be suspended, any support members can be employed as the support roller pair 113, and these may not always be rollers.

During a period lasting until the drying time has elapsed, while the colorimetry sheet P11 is held by the support roller pair 113, the normal image printing that does not require the colorimetric measurement results obtained for the color patches 104 can be performed. A non-colorimetry sheet P12, on which such a normal image is to be printed, is conveyed in the direction indicated by the arrow E1, as shown in FIG. 12B, and after such a normal image has been printed on the non-colorimetry sheet P12, the image bearing sheet P12 is guided to the discharge path 109. In a case wherein a long sheet, such as a roll sheet, is employed for the non-colorimetry sheet P12, the non-colorimetry sheet P12 is cut off by the cutter 122. During a period lasting until the drying time for the colorimetry sheet P11 has elapsed, printing of the non-colorimetry sheet P12 can be repeated.

When the drying time for the colorimetry sheet P11 has elapsed, the branching unit 106 is pivoted downward to form the colorimetry path 108, as shown in FIG. 12C. The colorimetry sheet P11 is then conveyed by the support roller pair 113 in the direction indicated by the arrow F2, while at the same time, colorimetric measurement of the color patches 104 is performed by the colorimetric measurement unit 114. During the colorimetric measurement process, the colorimetric measurement unit 114 is lowered as shown in FIG. 12C, and presses the colorimetric measurement portion of the colorimetric measurement unit 114 against the colorimetry sheet P11, which is positioned on the pressure plate 116 of the pressure plate unit 112. A support member 117 composed of an elastic material, such as a spring or rubber, is provided under the pressure plate 116, and when the colorimetric measurement unit 114 is lowered and presses against the colorimetry sheet P11, the support member 117 pushes the colorimetry sheet P11 up through the pressure plate 116, so that the portion of the colorimetry sheet P11 where the color patches 104 are printed is uniformly pressed against the colorimetric measurement portion of the colorimetric measurement unit 114. In this manner, the pressure plate unit 112 supports the colorimetry sheet P11 to uniformly press, against the colorimetric measurement portion of the colorimetric measurement unit 114, the portion wherein the color patches 104 have been printed.

When the colorimetry sheet P11 has been conveyed in the direction indicated by the arrow F2 until the upstream end, in the conveyance direction, has reached the position of the upstream conveying roller pair 111, the upstream conveying roller pair 111 conveys the colorimetry sheet P11 in cooperation with the support roller pair 113, in the direction indicated by an arrow E2, which is the same direction as that indicated by the arrow F2.

When the colorimetric measurement by the colorimetric measurement unit 114 has been completed, and the downstream end of the colorimetry sheet P11, in the conveyance direction (the direction indicated by the arrow F2), reaches the position upstream of the branching unit 106 in the conveyance direction (the position on the right in FIG. 12C), the branching unit 106 is pivoted as shown in FIG. 12B. Thereafter, the colorimetry sheet P11 is conveyed by the upstream conveying roller pair 111 in the direction indicated by the arrow E1, and is discharged along the discharge path 109.

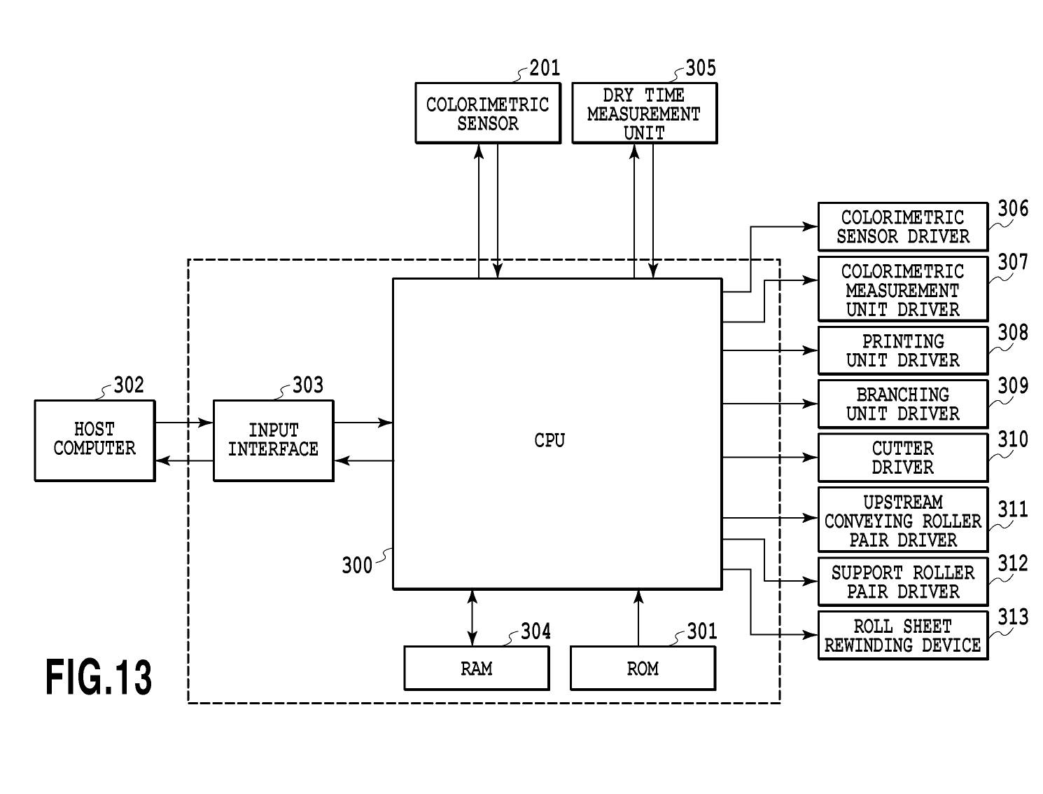

FIG. 13 is a block diagram illustrating the arrangement of the control system of the printing apparatus of this embodiment. A CPU 300A controls the overall operation of the printing apparatus, including the printing, the drying and the colorimetric measuring, based on a control program stored in a ROM 301. The CPU 300A receives, for example, print data and print mode setting information from a host computer 302 via an input interface 303. Furthermore, the CPU 300A writes the print data to a RAM 304, and reads the print data from the RAM 304. The CPU 300A controls the drivers 309 to 313 based on the print data, the print mode setting information and information related to colorimetric measurement received from the host computer 302, timing information obtained by a drying time measurement unit 305, and colorimetric data obtained by the colorimetric sensor 201. The drying time measurement unit 305 is a unit for measuring the time elapsed to dry the colorimetry sheet P11. The driver 306 is used for a colorimetric sensor, the driver 307 is used for a colorimetric measurement unit, the driver 308 is used for a printing unit, and the driver 309 is used for a branching unit. Further, the driver 310 is used for a cutter, the driver 311 is used for an upstream conveying roller pair, the driver 312 is used for a support roller pair, and the driver 313 is used for a roll sheet rewinding device.

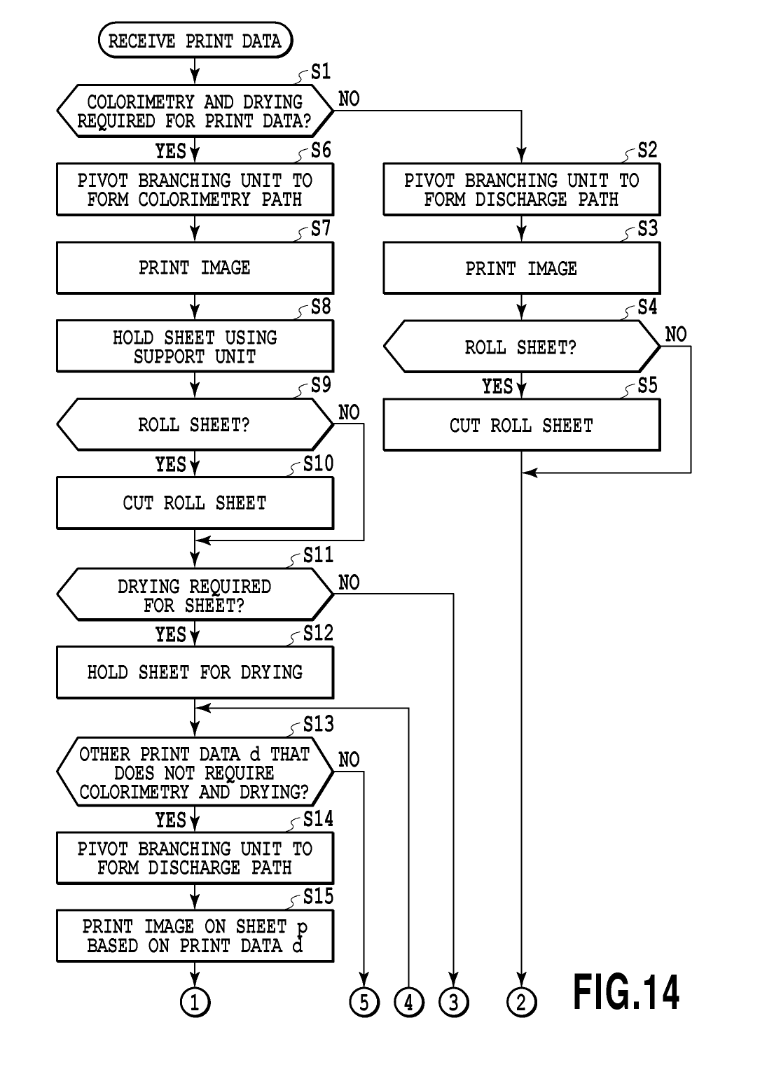

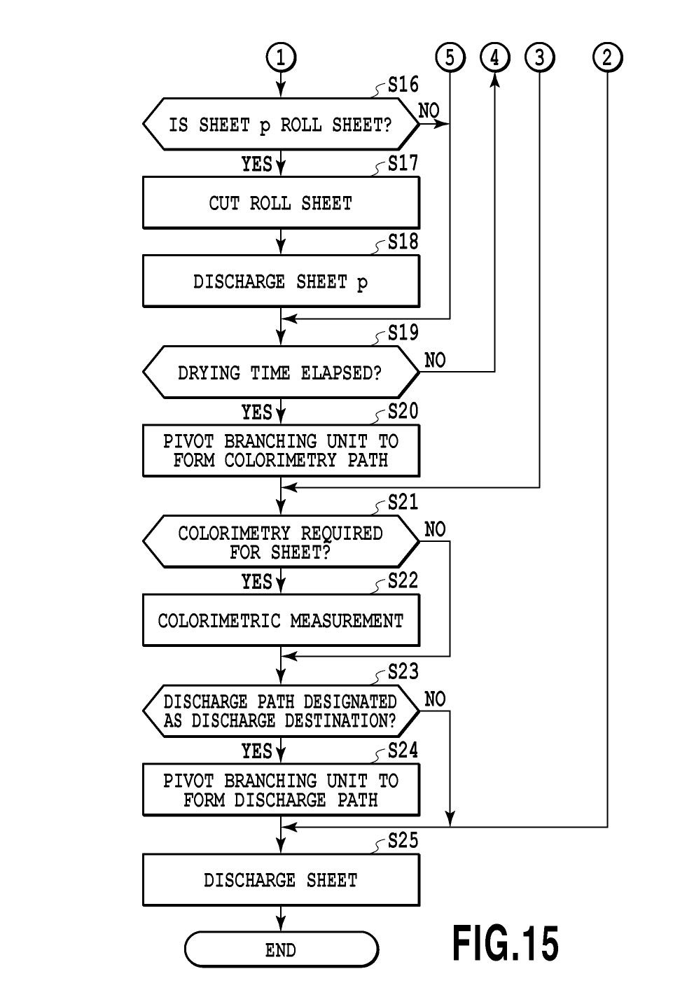

FIGS. 14 and 15 are flowcharts for explaining the operation performed by the printing apparatus, including the printing, the drying and the colorimetric measurement.

When print data has been received, first, a check is performed to determine whether colorimetric measuring or drying is required for a sheet on which the print data are printed (step S1). When neither colorimetric measuring nor drying is required for the printed sheet (including the non-colorimetry sheet P12), the branching unit 106 is pivoted to form the discharge path 109 (step S2), and an image is printed as shown in FIG. 11 (step S3). Thereafter, a check is performed to determine whether the printed sheet is part of a long sheet, such as a roll sheet (step S4), and when the printed sheet is part of a long sheet, the printed sheet is cut off by the cutter 122 (step S5) and discharged (step S25).

When colorimetric measuring or drying is required for the sheet on which printed data have been printed (including a colorimetry sheet P11), the branching unit 106 is pivoted to form the colorimetry path 108 (step S6), and an image (which includes the color patches 104) is printed (step S7). Then, the sheet is held by the support unit (the support roller pair 113) (step S8), and a check is performed to determine whether the printed sheet is part of a long sheet, such as a roll sheet (step S9). When the printed sheet is part of a long sheet, the sheet is cut off by the cutter 122 (step S10).

Following this, a check is performed to determine whether drying is required for the printed sheet (step S11), and when drying is not required for the sheet, this sheet is to be examined at step S21, which will be described later, to determine whether colorimetric measurement is required. When drying is required for the sheet, the sheet is natural-dried, while the sheet is held by the support unit, as shown in FIG. 12B (step S12).

During this drying period, a check is performed to determine whether other print data d, for which neither colorimetric measuring nor drying is required after printing, has been received (step S13). When the print data d is received, the branching unit 106 is pivoted to form the discharge path 109 (step S14), and based on the print data d, an image is printed on a sheet p (step S15). Thereafter, a check is performed to determine whether the sheet p is part of a long sheet, such as a roll sheet (step S16), and when the sheet p is part of a long sheet, the sheet p is cut off by the cutter 122 (step S17) and is discharged (step S18).

When printing has been completed for the print data d that does not require either colorimetric measurement or drying, a check is performed to determine whether the drying period for the sheet held by the support unit at step S12 has reached a predetermined setup period (step S19). When the drying period has not yet reached the setup period, program control returns to step S13. When the drying time has reached the setup period, the branching unit 106 is pivoted to form the colorimetry path 108 (step S20), and a check is performed to determine whether colorimetric measurement is required for the dried sheet (step S21). When colorimetric measurement is not required for the dried sheet, the sheet discharge destination is selected, as will be described later. When colorimetric measurement is required for the desired sheet, the colorimetric sensor 201 performs the colorimetric measurement of the color patches 104 within a colorimetric measurement range for each scan. That is, the sheet is conveyed in the directions indicated by the arrows E2 and F2 a distance that corresponds to the colorimetric measurement range for each scan performed by the colorimetric sensor 201, and the colorimetric measurement unit 114 is lowered each time to perform multiple colorimetric measurements in the colorimetric measurement range. In other words, as shown in FIG. 12C, the colorimetric measurement unit 114 is lowered to prepare a colorimetric measurement, and is elevated each time after the measurement has been completed. This movement is repeated, and the colorimetric measurement processing is performed for the entire range of the color patches 104 (step S22).

Subsequently, the discharge destination for the sheet following the colorimetric measurement has been performed is determined (step S23). When a location along the extension line of the colorimetry path 108 is designated as the discharge destination for the sheet for which the colorimetric measurement process at step S22 has not been performed, the sheet is discharged along the colorimetry path 108 (step S25). When a location along the extension line of the discharge path 109 is designated as the sheet discharge destination, the sheet is conveyed in the direction indicated by the arrow E2, and is temporarily located at a distance from the branching unit 106 in the direction indicated by the arrow E2. Thereafter, the branching unit 106 is pivoted to form the discharge path 109 (step S24), and the sheet is discharged along the discharge path 109 (step S25).

Whereas, in a case wherein a location along the extension line of the colorimetry path 108 is designated as the sheet discharge destination for a sheet for which the colorimetric measurement process has been performed at step S22, the colorimetry path 108 have already been formed when the colorimetric measurement process was previously performed, and thus, without the process being required, the sheet can be discharged along the colorimetry path 108 (step S25). In a case wherein a location along the extension line of the discharge path 109 is designated as the sheet discharge destination, the sheet is conveyed in the direction indicated by the arrow E2, and is temporarily located at a distance from the branching unit 106 in the direction indicated by the arrow E2. Thereafter, the branching unit 106 is pivoted to form the discharge path 109 (step S24), and the sheet is discharged along the discharge path 109 (step S25).

Simply the holding of the colorimetry sheet P11 is required of the support roller pair 113, and the positions of these rollers are not limited to those of this embodiment. For example, the support roller pair 113 may be located between the branching unit 106 and the pressure plate unit 112. Further, the position of the pivotal support for the branching unit 106 is not limited to the position downstream in the direction indicated by the arrow E1 or F2, and so long as the sheet conveyance direction can be changed, any structure may be employed for the branching unit 106. The pivotal support for the branching unit 106 may be located upstream in the direction indicated by either the arrow E1 or F2.

Furthermore, in this embodiment, after the colorimetric measurement has been performed, the colorimetry sheet P11 is guided to the discharge path 109 by the branching unit 106, and is discharged. However, the colorimetry sheet P11 may be returned to the colorimetry path 108, and may also be discharged by using the support roller pair 113 located at the extension line of the colorimetry path 108. Therefore, the user can separate the discharge destinations for the colorimetry sheet P11 and for the non-colorimetry sheet P12. Further, the sheet for which colorimetric measurement is not required (including the non-colorimetry sheet P12) may be guided to the calorimetric path 108, so that the sheet can be appropriately dried before being discharged. Moreover, the branching unit 106 may switch between a plurality of conveyance paths for colorimetry sheets, and a support unit (support roller pair 113) may be arranged along each of these conveyance paths, so that a plurality of sheets can be dried at the same time.

In this embodiment, the printing unit is arranged upstream of the colorimetric measurement unit, and when a sheet has been conveyed along the first path, an image requiring colorimetric measurement is printed on the sheet by the printing unit, and the image bearing sheet is conveyed downstream and is moved from the first path to the second path. Thereafter, the sheet is held along the second path, and then, is conveyed upstream, and colorimetric measurement is performed for the sheet by the colorimetric measurement unit. According to the arrangement and the operation described above, the same operating effects obtained in the first embodiment can also be provided.

### Fourth Embodiment

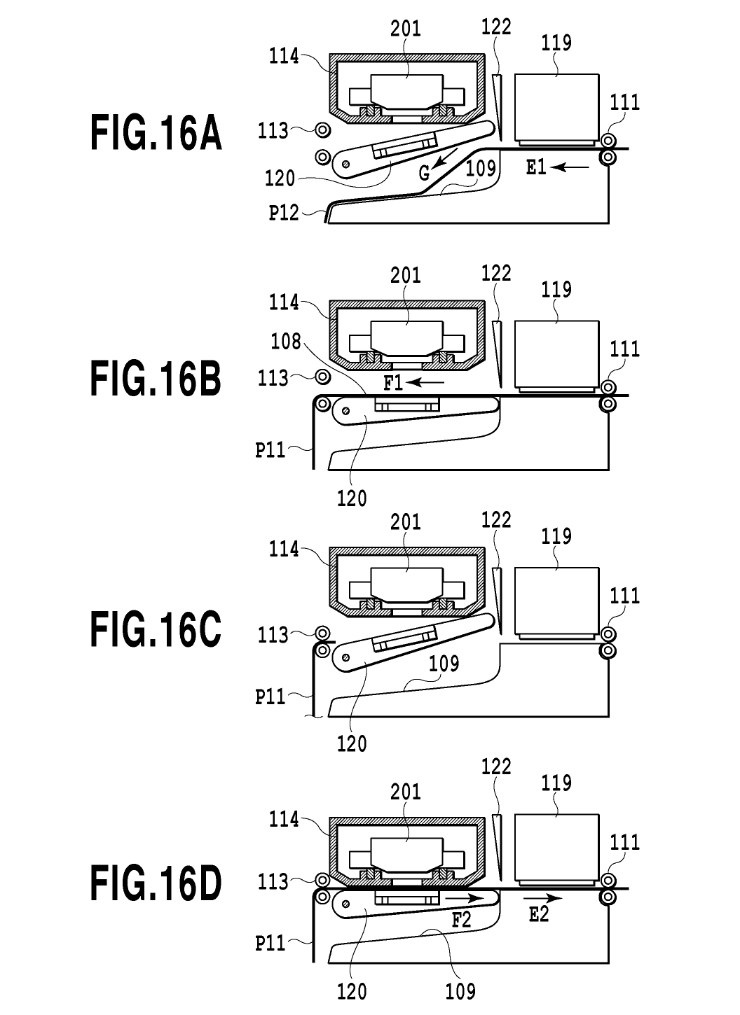

FIGS. 16A, 16B, 16C and 16D are diagrams for explaining a fourth embodiment of the present invention, and the same reference numerals as used in the third embodiment are provided for the corresponding portions, and no further explanation will be given.

FIG. 16A is a diagram showing the state in which image printing is performed for a non-colorimetry sheet P12. In this embodiment, a pressure-plate-combined branching unit 120 (switching means) is provided that is an integrated unit of the branching unit 106 and the pressure plate unit 112 in the third embodiment. In this case as well as in the third embodiment, as shown in FIG. 16A, the pressure-plate-combined branching unit 120 is pivoted upward to form a discharge path 109, so that the printing and discharging of a non-colorimetry sheet P12 can be performed. The arrangement, other than the integrated unit of the branching unit 106 and the pressure plate unit 112, is the same as that for the third embodiment.

In the state in FIG. 16B, the colorimetry sheet P11 is conveyed to the colorimetry path 108. At this time, the pressure-plate-combined branching unit 120 is pivoted downward to form the colorimetry path 108. In the state in FIG. 16C, after the printing of color paths 104 is completed, the colorimetry sheet P11 is supported for drying. At this time, the pressure-plate-combined branching unit 120 is pivoted upward to form the discharge path 109. When an image that does not require the colorimetric measurement of the color patches 104 is to be printed while the colorimetry sheet P11 is being dried, printing for the non-colorimetry sheet P12 is performed as shown in FIG. 16A, while the colorimetry sheet P11 is held by the support roller pair 113.

In the state in FIG. 16D, when the drying time for the colorimetry sheet P11 has elapsed, the colorimetric measurement unit 114 performs colorimetric measurement for the color patches 104 of the colorimetry sheet P11. At this time, the pressure-plate-combined branching unit 120 is pivoted upward to form the colorimetry path 108. The colorimetric measurement for the colorimetry sheet P11 is performed by the colorimetric measurement unit 114, while the sheet P11 is being conveyed by the support roller pair 113 in the direction indicated by the arrow F2.

When the pressure-plate-combined branching unit 120 is provided as in this embodiment, the distance between the printing unit 119 and the support roller pair 113 can be reduced, and the marginal sizes at the leading end and the trailing end of the colorimetry sheet P11 in the conveyance direction can be reduced to save the sheet. Further, when the distance between the printing unit 119 and the support roller pair 113 becomes shorter, the size of the entire printing apparatus can also be reduced.

### Fifth Embodiment

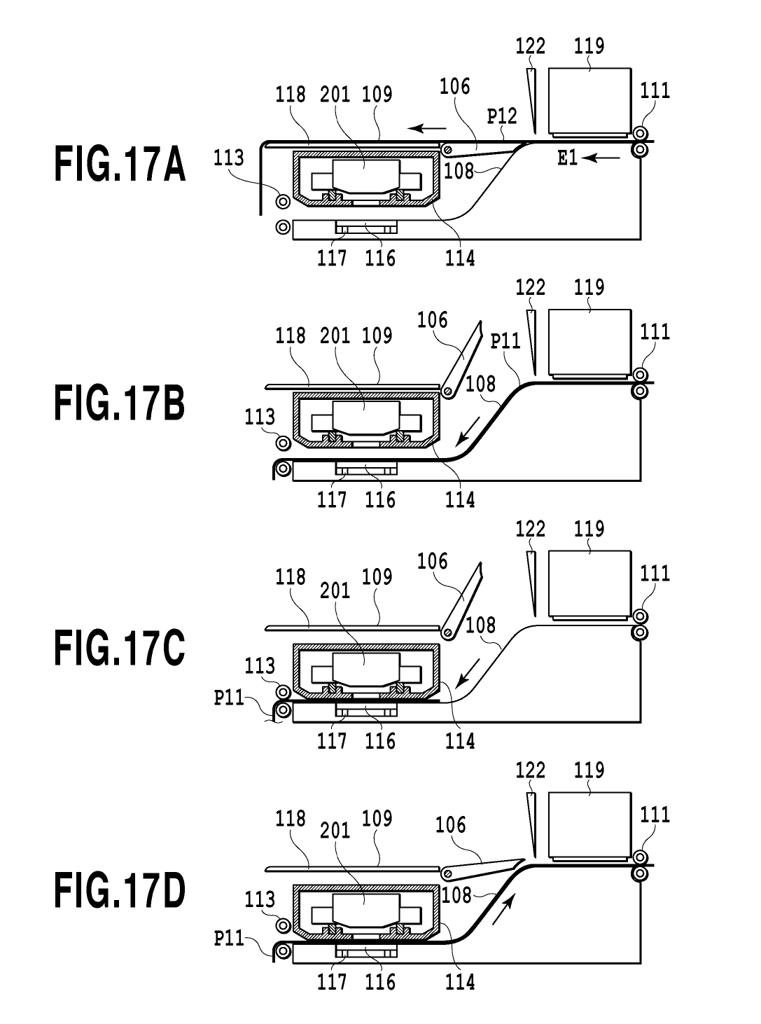

FIGS. 17A, 17B, 17C and 17D are diagrams for explaining a fifth embodiment of the present invention. The same reference numerals as used for the above described embodiments are also provided for the corresponding portions, and no further explanation will be given.

In the state in FIG. 17A, image printing is performed for a non-colorimetry sheet P12. In the third embodiment previously described, the path extended above the branching unit 106 is provided as the colorimetry path 108, while in this embodiment, the path extended below the branching unit 106 is provided as a colorimetry path 108. Therefore, in this embodiment, the pressure plate unit 112 used for the third embodiment is integrally formed with the main body of the printing apparatus. That is, the pressure plate 116 that uniformly presses a colorimetry sheet P11 against the colorimetric measurement unit 114 and the support member 117 that supports the pressure plate 116 are arranged on the main body of the printing apparatus. When the colorimetry path 108 is formed, the pressure plate unit 112 may be separated from the main body of the printing apparatus. Further, a conveyance plate 118 is additionally provided to form the discharge path 109. Except for the vertical positional relationship between the colorimetry path 108 and the discharge path 109, separated by the branching unit 106, the arrangement for this embodiment is the same as that for the third embodiment.

In this arrangement, a first path is extended from a sheet supply unit (not shown) via the printing unit 119 until the cutter 122. A second path is the colorimetry path 108.

In the state in FIG. 17B, a colorimetry sheet P11 is conveyed to the colorimetry path 108. At this time, the branching unit 106 is pivoted upward to provide the colorimetry path 108 below. In the state in FIG. 17C, after printing of color patches 104 is completed, the colorimetry sheet P11 is supported for drying. When an image that does not require the colorimetric measurement result of the color patches 104 is to be printed in a period in which the colorimetry sheet P11 is held for drying, printing is performed for a non-colorimetry sheet P12, as shown in FIG. 17A, while the colorimetry sheet P11 is being held by the support roller pair 113.

In the state in FIG. 17D, after the drying time for the colorimetry sheet P11 has elapsed, calorimetric measurement by the colorimetric measurement unit 114 is performed for the color patches 104 of the colorimetry sheet P11. When the colorimetric measurement unit 114 has performed the colorimetric measurement for the colorimetry sheet P11, the colorimetry sheet P11 is conveyed by the support roller pair 113 in a direction toward the printing unit 119, indicated by an arrow in FIG. 17D. At this time, the branching unit 106 is pivoted downward, as shown in FIG. 17D, and guides the leading edge of the colorimetry sheet P11 conveyed from the colorimetric measurement unit 114, so that the colorimetry sheet P11 is smoothly moved toward the printing unit 119.

In this embodiment, the non-colorimetry sheet P12 is discharged from the side (upper side) above the obverse face of the colorimetry sheet P11 that is supported by the support roller pair 113 and is being dried. Therefore, compared with the third embodiment wherein the non-colorimetry sheet P12 is discharged from the side (lower side) below the reverse face of the colorimetry sheet P11 that is held by the support roller pair 113 and is being dried, the non-colorimetry sheet P12 that has been discharged can be easily removed from the sheet discharge portion. Further, when the colorimetry sheet P11 is held by the support roller pair 113, the end of the colorimetry sheet P11 in the conveyance direction may be maintained inside the main body of the printing apparatus to perform drying and storing of the colorimetry sheet P11.

### Sixth Embodiment

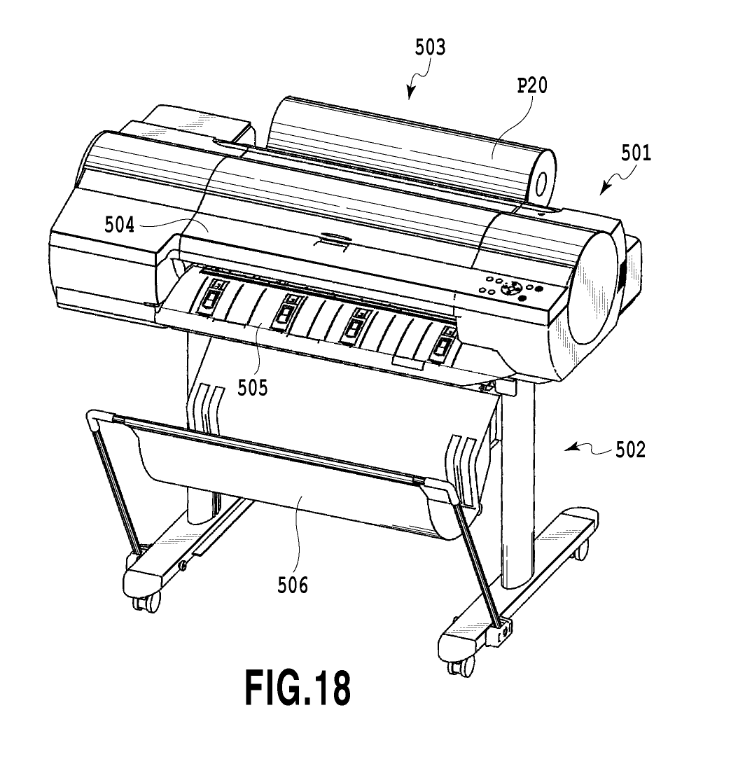

FIG. 18 is a perspective view of a printing apparatus according to a sixth embodiment of the present invention. A main body 501 of a printing apparatus is supported by a stand 502, and a sheet P20 that is a printing medium is to be supplied by a sheet supply unit 503. The sheet P20 in this embodiment is a long sheet wound like a roll. In the main body 501, a colorimetric measurement unit 504 performs colorimetric measurement for color patches that are printed on the sheet P20. When an image, including colorimetric color patches, is printed on the sheet, the printed sheet portion is discharged from a discharge portion 505, and is stored in a storage unit 506.

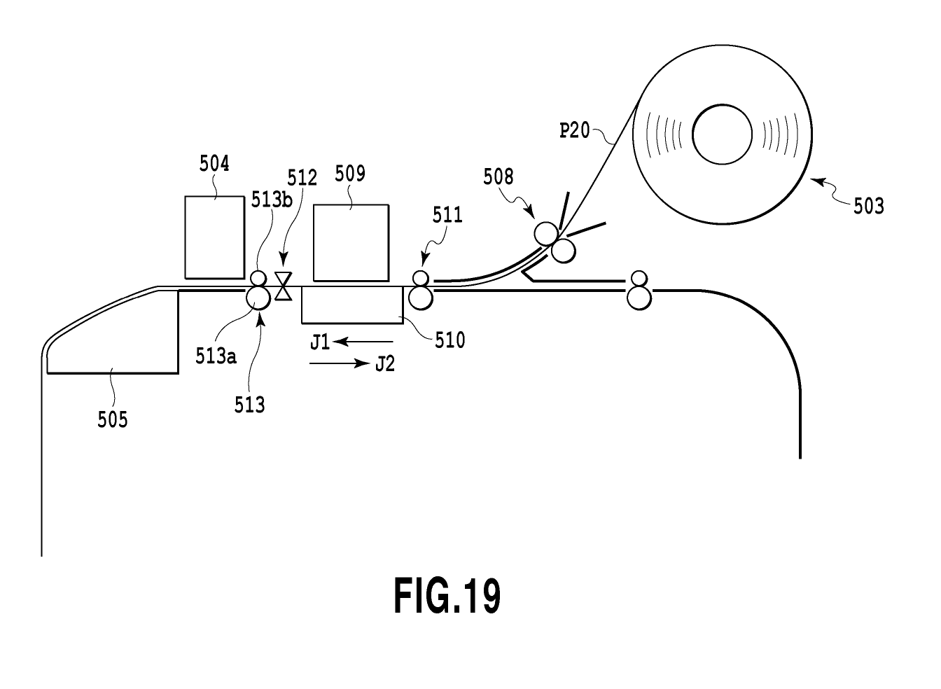

FIG. 19 is a schematic diagram illustrating the arrangement of the essential portion of the printing apparatus in this embodiment. The sheet P20 in FIG. 19 is conveyed, so that the leading edge is externally exposed from the discharge portion 505. In FIG. 19, the stand 502 is not shown. A feeding roller pair 508 feeds the roll sheet P20 that is set to the sheet supply unit 503, and a printing unit 509 reciprocates a print head in a direction perpendicular to the surface of the paper in FIG. 19 to print an image on the sheet P20. A platen 510 is located at the position opposite to the printing unit 509, and multiple holes (not shown) are formed in the surface of the platen 510. The sheet P20 is drawn by suction through the holes of the platen 510 by a fan (not shown), so that the position of the sheet P20 is controlled to appropriately perform printing. An upstream conveying roller pair 511 conveys the sheet P20 to the printing unit 509. A cutter 512 cuts off the printed portion of the sheet P20, and allows the printed portion to drop in the storage unit 506. A colorimetry conveying roller pair 513 consists of a lower drive roller 513a and an upper driven roller 513b. The upper roller 513b can be brought in contact with, or separated from the lower roller 513a, and is generally retracted upward and separated from the lower roller 513a, except for the case wherein the colorimetric measurement unit 504 performs colorimetric measurement. In the state in FIG. 19, the printing unit 509 has completed printing of color patches used for colorimetric measurement, and the upper roller 513b of the colorimetry conveying roller pair 513 is lowered and is holding the sheet P20, together with the lower roller 513a. Thereafter, the printed portion of the sheet P20 is cut off by the cutter 12.

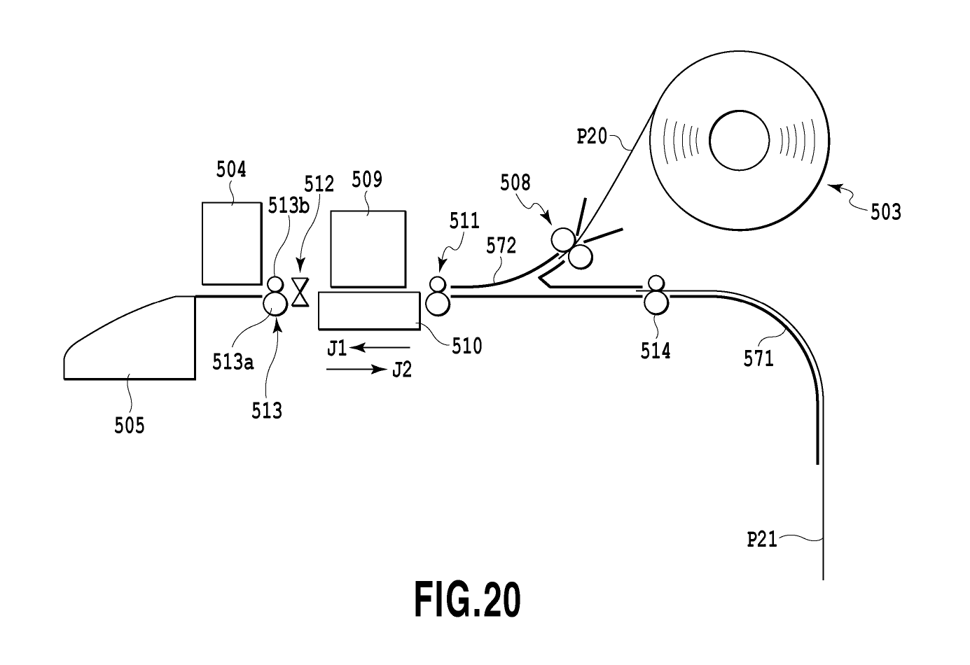

The state in FIG. 20 follows the state in FIG. 19. First, the printed portion of the sheet P20 is cut off by the cutter 512, and the remaining sheet P20 on the sheet supply unit 503 side is rewound until the leading edge reaches the feeding roller pair 508. A sheet P21, which is cut off by the cutter 512, is conveyed in a direction indicated by an arrow J2 by the colorimetry conveying roller pair 513, the upstream conveying roller pair 511 and a support roller pair 514, and is guided to a branch path 571. Conveying of the sheet P21 is halted when the support roller pair 514 holds the end portions of the sheet P21, as shown in FIG. 20. Since the color patches for colorimetric measurement are printed on the sheet P21, this sheet is also called a colorimetry sheet.

According to this arrangement, a first path is extended from the sheet supply unit 503 via the printing unit 509 to the cutter 512. A second path is the branch path 571. Drying of the colorimetry sheet P21 is performed when one part of the sheet P21 is held by the support roller pair 514 along the branch path 571 that is the second path. The branch path 571 is a different path from a conveyance path 572 extended between the feeding roller pair 508 and the discharge portion 505 and used for normal image printing. Therefore, the colorimetry sheet P21 that is being dried does not interrupt the normal image printing. When a predetermined drying time period has elapsed, the colorimetry sheet P21 that has been dried is conveyed in a direction indicated by the arrow J1 by reversely rotating the support roller pair 514, the colorimetric measurement for the color patches is performed by the colorimetric measurement unit 504, and thereafter, the colorimetry sheet P21 is discharged from the discharge portion 505.

### Seventh Embodiment

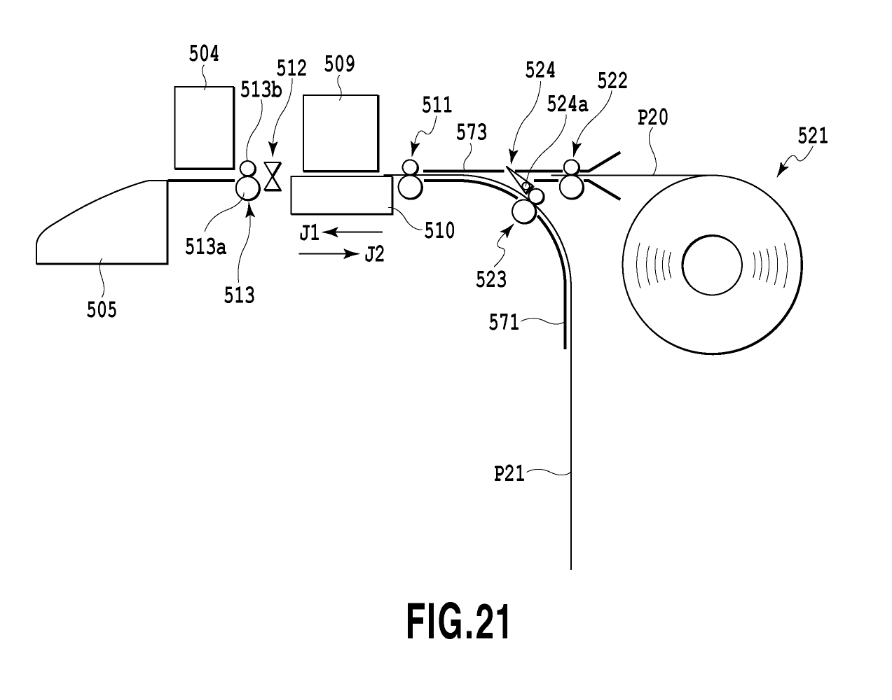

FIG. 21 is an explanatory diagram for a seventh embodiment of the present invention. Since the arrangement downstream of an upstream conveying roller pair 511 in a direction indicated by an arrow J1 is the same as that for the sixth embodiment, no further explanation for this will be given.

The sheet P20 for this embodiment is a roll sheet, and is supplied from a sheet supply unit 521. The roll sheet P20 set at the sheet supply unit 521 is fed by a feeding roller pair 522. In this embodiment, a conveyance path 573 is formed almost horizontally from the feeding roller pair 522 to the upstream conveying roller pair 511. When color patches for colorimetric measurement are printed on the sheet P20, the printed portion of the sheet P20 is cut off by the cutter 512 as the colorimetry sheet P21, which is then conveyed in the direction indicated by the arrow J2 by the colorimetry conveying roller pair 513, the upstream conveying roller pair 511 and a support roller pair 523, and is guided to the branch path 571. The conveying of the colorimetry sheet P21 is halted when the end portion of the colorimetry sheet P21 is held by the support roller pair 523, as shown in FIG. 21.

A flapper 524 (switching means) is rotatable at a rotation center 524a, and is generally urged into a upward pivoting position in FIG. 21 by a spring (not shown). In this state, when the colorimetry sheet P21 is conveyed in the direction indicated by the arrow J2, the colorimetry sheet P21 is guided by the flapper 524 toward the support roller pair 523 and the branch path 571. Whereas, when the sheet P20 is fed from the sheet supply unit 521 by the feeding roller pair 522, the leading edge of the sheet P20 hits against the flapper 524. However, since the force of the spring (not shown) that urges the flapper 524 into the upward pivoting position is weak, the sheet P20 pushes down the flapper 524 against the urging force of the spring, and is conveyed toward the upstream conveying roller pair 511.

Also in this embodiment, a first path is extended from the sheet supply unit 521 via the printing unit 509 to the cutter 512, and a second path is the branch path 571. The branch path 571 is a different path from a conveyance path extended from the feeding roller pair 522 to the discharge portion 505 and used for the normal printing. Therefore, during the drying period, the colorimetry sheet P21 does not interrupt the normal printing operation. When a predetermined drying time period has elapsed, the colorimetry sheet P21 that is dried is conveyed in the direction indicated by the arrow J1 by reversely rotating of the support roller pair 523, colorimetric measurement for the color patches is performed by the colorimetric measurement unit 504, and the colorimetry sheet P21 is externally discharged from the discharge portion 505.

### Eighth Embodiment

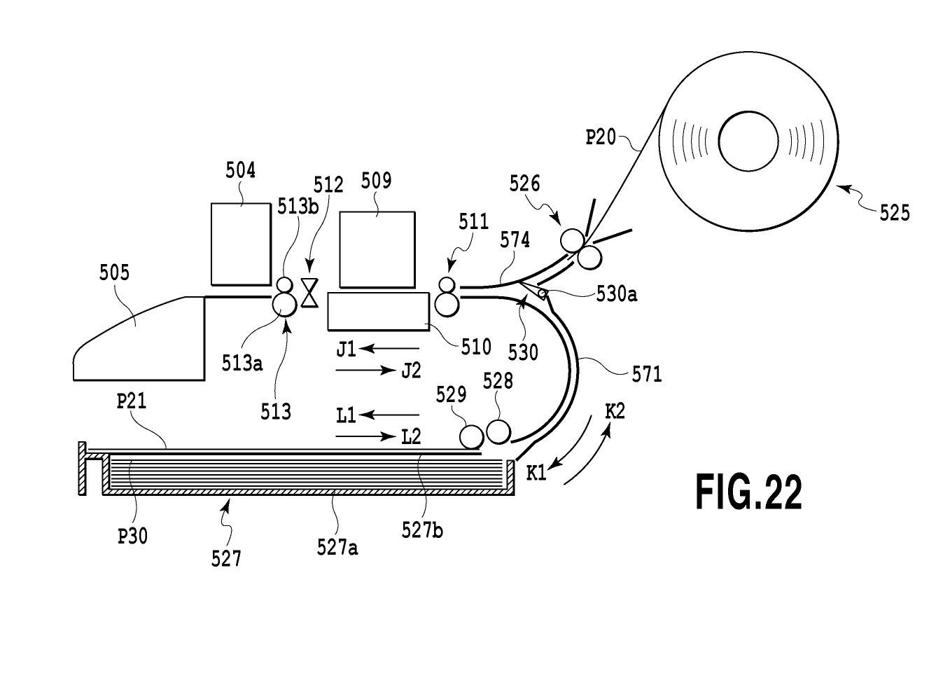

FIG. 22 is a diagram for explaining an eighth embodiment of the present invention. Since the arrangement for the sixth embodiment is employed for the portion downstream of the upstream conveying roller pair 511 in the direction indicated by the arrow J1, no further explanation for this portion will be given.

The sheet P20 for this embodiment is a long sheet wound like a roll, and is supplied from a sheet supply unit 525. The roll sheet P20 set at the sheet supply unit 525 is fed by a feeding roller pair 526. In this embodiment, a conveyance path 574 is curved from the feeding roller pair 526 to the upstream conveying roller pair 511. A sheet cassette 527 that includes a sheet storage portion 527a and a partition plate 527b is used to store multiple sheets P30 in a cut sheet form that is different from the sheet P20. Each of the sheets P30 stored in the storage portion 527a is fed by a second feeding roller 528. For feeding the sheets P30, the second feeding roller 528 is moved down from the upper position in FIG. 22, and contacts the topmost sheet P30 stacked in the sheet cassette 527. Therefore, when the second feeding roller 528 is rotated, the topmost sheet P30 can be conveyed in a direction indicated by an arrow K2 from a branch path 571 toward the printing unit 509. When the colorimetry sheet P21 has been conveyed by the colorimetry conveying roller pair 513 and the upstream conveying roller pair 511 along the branch path 571 in the direction indicated by an arrow K1, the colorimetry sheet P21 is thereafter conveyed by a cassette conveying roller 529 in a direction indicated by an arrow L1, and is held on the partition plate 527b and is dried.

A flapper 530 (switching means) is rotatable at a rotation center 530a, and is generally urged into a upward pivoting position in FIG. 22 by a spring (not shown). In this state, when the colorimetry sheet P21 is conveyed in the direction indicated by the arrow J2, the colorimetry sheet P21 is guided by the flapper 530 toward the branch path 571 and the partition plate 527b. Whereas when the sheet P20 is fed from the sheet supply unit 525 by the feeding roller pair 526, the leading edge of the sheet P20 hits against the flapper 530. However, since the force of the spring (not shown) that urges the flapper 530 into the upward pivoting position is weak, the sheet P20 pushes down the flapper 530 against the urging force of the spring, and is conveyed toward the upstream conveying roller pair 511.

In this embodiment, the colorimetry sheet P21 is held on the partition plate 527b, which is located at the position separated from a conveyance path that is extended from the feeding roller pair 526 to the discharge portion 505 and is used for printing the sheet P20, and a conveyance path that is extended from the second feeding roller 528 to the discharge portion 505 and is used for printing the sheet P30. Therefore, during the drying period, the colorimetry sheet P21 does not bother the normal printing for the sheets P20 and P30. After a predetermined drying period has elapsed, the cassette feeding roller 529 is reversely rotated, and the colorimetry sheet P21 that has been dried is conveyed in the directions indicated by the arrows L2 and K2. Furthermore, the colorimetry sheet P21 that has been dried is conveyed by the colorimetry conveying roller pair 513 and the upstream conveying roller pair 511 in the direction indicated by the arrow J1, colorimetric measurement for color patches is performed by the colorimetric measurement unit 504, and thereafter, the colorimetry sheet P21 is externally discharged from the discharge portion 505.

In this embodiment, a first path includes a path extended from the sheet supply unit 525 via the printing unit 509 to the cutter 512 and a path extended from the sheet cassette 527 via the branch path 571 to the cutter 512. A second path is the branch path 571. That is, the branch path 571 is employed in common for the first path and the second path.

For the sixth to the eighth embodiments, a space used to dry the colorimetry sheet P21 is formed in the main body of the printing apparatus on the same side as the non-printed face of a sheet that is conveyed from the sheet supply unit to the printing unit. That is, when the face of the sheet to be printed by the printing unit is regarded as an upper face, the space used to dry the colorimetry sheet is prepared in the printing apparatus at the position on the same side as the lower face of the sheet (non-printed face).

### Ninth Embodiment

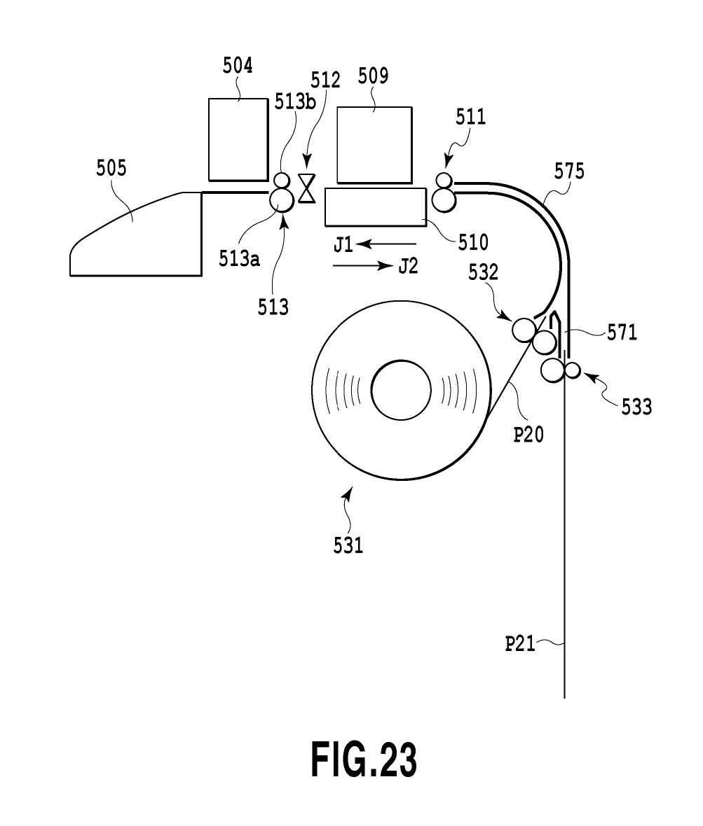

FIG. 23 is an explanatory diagram for a ninth embodiment of the present invention. Since the arrangement for the sixth embodiment is employed for the portion downstream of the upstream conveying roller pair 511 in the direction indicated by the arrow J1, no further explanation for this portion will be given.

The sheet P20 for this embodiment is a roll sheet, and is supplied from a sheet supply unit 531. The roll sheet P20 set at the sheet supply unit 531 is fed by a feeding roller pair 532. In this embodiment, a conveyance path 575 is curved from the feeding roller pair 532 to the upstream conveying roller pair 511. When color patches for colorimetric measurement are printed on the sheet P20, the printed portion of the sheet P20 is cut off by the cutter 512 as the colorimetry sheet P21, which is then conveyed in the direction indicated by the arrow J2 by the colorimetry conveying roller pair 513, the upstream conveying roller pair 511 and a support roller pair 533, and is guided to a branch path 571. The conveying of the colorimetry sheet P21 is halted when the end portion of the colorimetry sheet P21 is held by the support roller pair 533, as shown in FIG. 23.

Also in this embodiment, a first path is extended from the sheet supply unit 531 via the conveyance path 575 and the printing unit 509 to the cutter 512, and a second path includes the conveyance path 575 and the branch path 571. That is, the conveyance path 575 is employed in common with the first path and the second path. The branch path 571 is a different path from a conveyance path that is extended from the feeding roller pair 532 to the discharge portion 505 and is used for normal printing. Therefore, during the drying period, the colorimetry sheet P21 does not interrupt the normal printing operation. When a predetermined drying time period has elapsed, the support roller pair 533 and the upstream conveying roller pair 511 are reversely rotated to convey the colorimetry sheet P21 that has been dried in the direction indicated by the arrow J1. Thereafter, colorimetric measurement for the color patches is performed by the colorimetric measurement unit 504, and the colorimetry sheet P21 is externally discharged from the discharge portion 505.

In this embodiment, one part of the conveyance path (feeding path) 575, along which the sheet is fed from the sheet supply unit (feeding unit) 531, and the branch path 571 are employed to form the second path used for drying the colorimetry sheet. Therefore, the second path is included in the conveyance path (feeding path) used for feeding the sheet.

### Tenth Embodiment

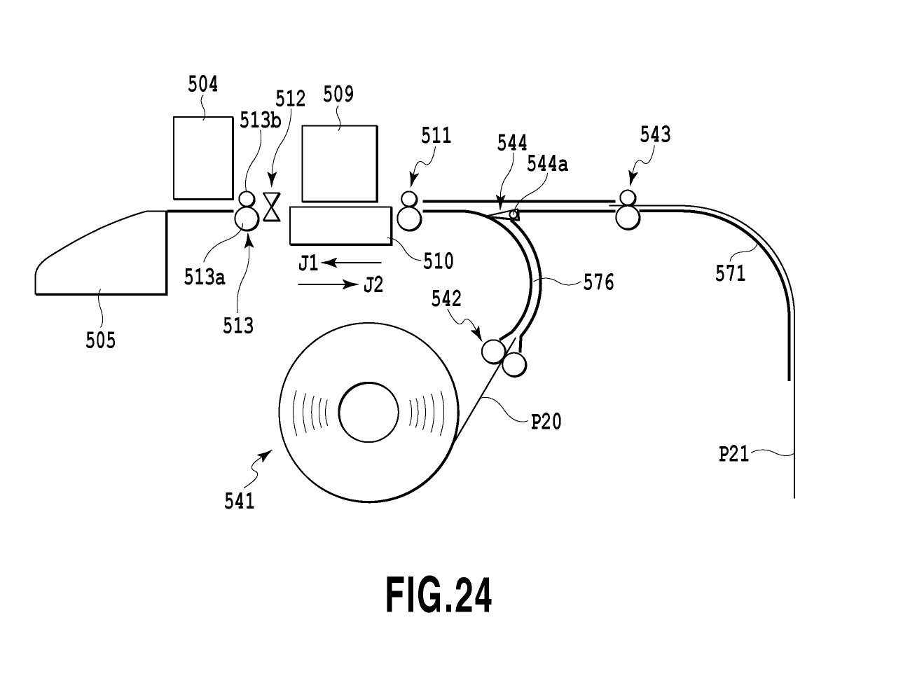

FIG. 24 is an explanatory diagram for a tenth embodiment of the present invention. Since the arrangement downstream of the upstream conveying roller pair 511 in the direction indicated by the arrow J1 is the same as that for the sixth embodiment, no further explanation for this portion will be given.

The sheet P20 for this embodiment is a roll sheet, and is supplied from a sheet supply unit 541. The roll sheet P20 set at the sheet supply unit 541 is fed by a feeding roller pair 542. In this embodiment, a conveyance path 576 is curved from the feeding roller pair 542 to the upstream conveying roller pair 511. When color patches for colorimetric measurement are printed on the sheet P20, the printed portion of the sheet P20 is cut off by the cutter 512 as the colorimetry sheet P21, which is then conveyed in the direction indicated by the arrow J2 by the colorimetry conveying roller pair 513, the upstream conveying roller pair 511 and a support roller pair 543, and is guided to a branch path 571. The conveying of the colorimetry sheet P21 is halted when the end portion of the colorimetry sheet P21 is held by the support roller pair 543, as shown in FIG. 24.

A flapper 544 (switching means) is rotatable at a rotation center 544a, and is generally urged into a downward pivoting position in FIG. 24 by a spring (not shown). In this state, when the colorimetry sheet P21 is conveyed in the direction indicated by the arrow J2, the colorimetry sheet P21 is guided by the flapper 544 toward the support roller pair 543 and the branch path 571. When the sheet P20 is fed from the sheet supply unit 541 by the feeding roller pair 542, the leading edge of the sheet P20 hits the flapper 544. However, since the force of the spring (not shown) that urges the flapper 544 into the downward pivoting position is weak, the sheet P20 pushes the flapper 544 up against the urging force of the spring, and is conveyed toward the upstream conveying roller pair 511.

Also in this embodiment, a first path is extended from the sheet supply unit 541 via the conveyance path 576 and the printing unit 509 to the cutter 512, and a second path is the branch path 571. The branch path 571 is a different path from a conveyance path extended from the feeding roller pair 542 to the discharge portion 505 and is used for normal printing. Therefore, during the drying period, the colorimetry sheet P21 does not interrupt the normal printing operation. When a predetermined drying time period has elapsed, the support roller pair 543 and the upstream conveying roller pair 511 are reversely rotated, and the pried colorimetry sheet P21 is conveyed in the direction indicated by the arrow J1. Thereafter, colorimetric measurement for the color patches is performed by the colorimetric measurement unit 504, and the colorimetry sheet P21 is externally discharged from the discharge portion 505.

### Eleventh Embodiment

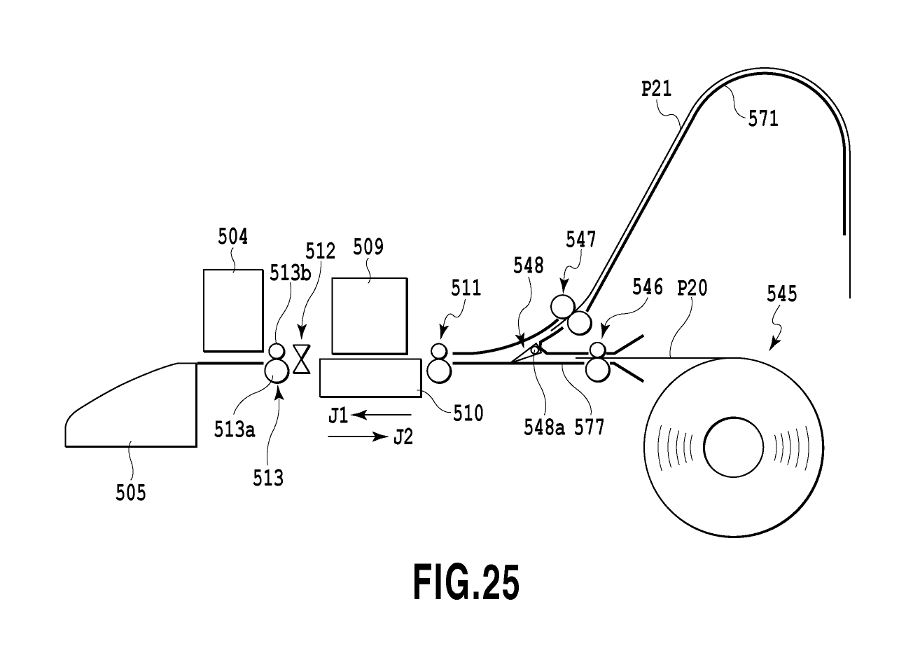

FIG. 25 is an explanatory diagram for an eleventh embodiment of the present invention. Since the arrangement downstream of the upstream conveying roller pair 511 in the direction indicated by the arrow J1 is the same as that for the sixth embodiment, no further explanation for this portion will be given.

The sheet P20 for this embodiment is a roll sheet, and is supplied from a sheet supply unit 545. The roll sheet P20 set at the sheet supply unit 545 is fed by a feeding roller pair 546. In this embodiment, a conveyance path 577 is formed almost horizontally from the feeding roller pair 546 to the upstream conveying roller pair 511. When color patches for colorimetric measurement are printed on the sheet P20, the printed portion of the sheet P20 is cut off by the cutter 512 as the colorimetry sheet P21, which is then conveyed in the direction indicated by the arrow J2 by the colorimetry conveying roller pair 513 and the upstream conveying roller pair 511, and is guided to a branch path 571. The conveying of the colorimetry sheet P21 is halted when the end portion of the colorimetry sheet P21 is held by a support roller pair 547, as shown in FIG. 25.

A flapper 548 (switching means) is rotatable at a rotation center 548a, and is generally urged into a downward pivoting position in FIG. 25 by a spring (not shown). In this state, when the colorimetry sheet P21 is conveyed in the direction indicated by the arrow J2, the colorimetry sheet P21 is guided by the flapper 548 toward the support roller pair 547 and the branch path 571. When the sheet P20 is fed from the sheet supply unit 545 by the feeding roller pair 546, the leading edge of the sheet P20 hits the flapper 548. However, since the force of the spring (not shown) that urges the flapper 548 into the downward pivoting position is weak, the sheet P20 pushes the flapper 548 up against the urging force of the spring, and is conveyed toward the upstream conveying roller pair 511.

Also in this embodiment, a first path is extended from the sheet supply unit 545 via the conveyance path 577 and the printing unit 509 to the cutter 512, and a second path is the branch path 571. The branch path 571 is a different path from a conveyance path extended from the feeding roller pair 546 to the discharge portion 505 and is used for normal printing. Therefore, during the drying period, the colorimetry sheet P21 does not interrupt the normal printing operation. When a predetermined drying time period has elapsed, the support roller pair 547 and the upstream conveying roller pair 511 are reversely rotated to convey the colorimetry sheet P21 that has been dried in the direction indicated by the arrow J1, and colorimetric measurement for the color patches is performed by the colorimetric measurement unit 504. Thereafter, the colorimetry sheet P21 is externally discharged from the discharge portion 505.

For the ninth to the eleventh embodiments, a space used to dry the colorimetry sheet P21 is formed in the main body of the printing apparatus on the same side as the printed face of the sheet that is conveyed from the sheet supply unit to the printing unit. That is, when the face of the sheet to be printed by the printing unit is regarded as an upper face, the space used to dry the colorimetry sheet is prepared in the printing apparatus at the position on the same side as the upper face of the sheet.

### Twelfth Embodiment

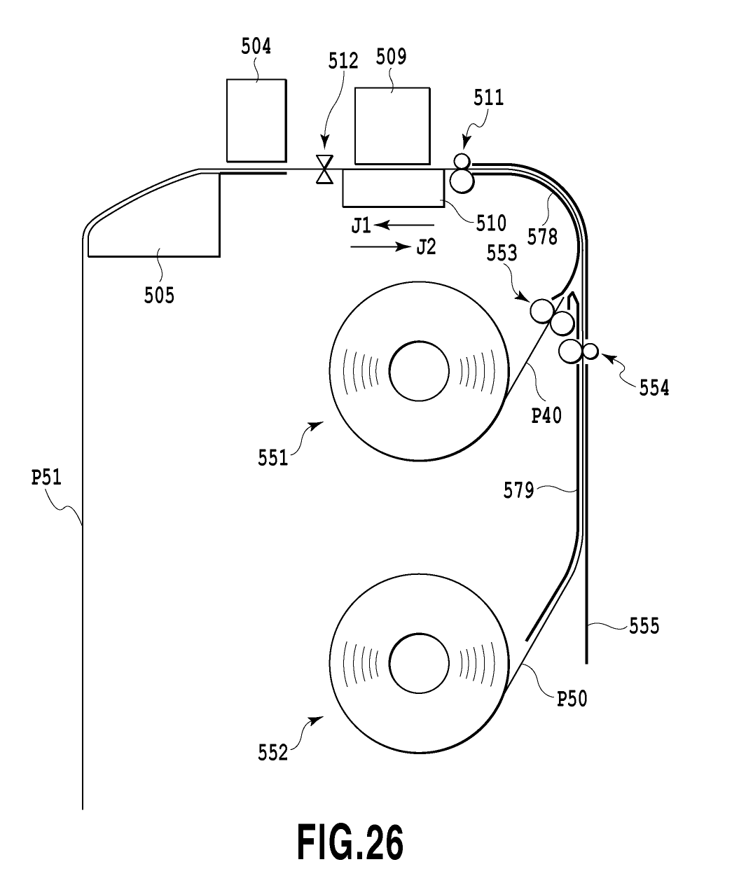

FIGS. 26 to 28 are explanatory diagrams for a twelfth embodiment of the present invention. Since the arrangement downstream of the upstream conveying roller pair 511 in the direction indicated by the arrow J1 is the same as that for the sixth embodiment, no further explanation for this portion will be given. In this embodiment, the colorimetry conveying roller pair 513 provided for the sixth embodiment are not employed.

A roll sheet P40 is set to a first sheet supply unit 551, and is to be fed by a first feeding roller pair 553. A conveyance path 578 extended from the feeding roller pair 553 to the upstream conveying roller pair 511 is curved. A roll sheet P50 is set to a second sheet supply unit 552, and is to be fed by a second feeding roller pair 554 along a conveyance path 579. The second feeding roller pair 554 can hold a colorimetry sheet portion where color patches used for colorimetric measurement are printed, which will be described later. A conveyance guide 555 can be moved in a direction separated from the conveyance path 579, as will be described later.

In the state in FIG. 26, for colorimetric measurement, the printing unit 509 has printed color patches on the sheet P50 that is fed by the second sheet supply unit 552, and thereafter, the leading edge of the sheet P50 is externally discharged from the discharge portion 505. At this time, as for the sheet P40 set at the first sheet supply unit 551, the portion near the leading edge is held by the first feeding roller pair 553. As shown in FIG. 26, the portion of the sheet P50, on which the color patches are printed and which is externally discharged from the discharge portion 505, corresponds to a colorimetry sheet P that has not yet been cut off, and hereinafter, this portion is also called a colorimetry sheet portion P51.

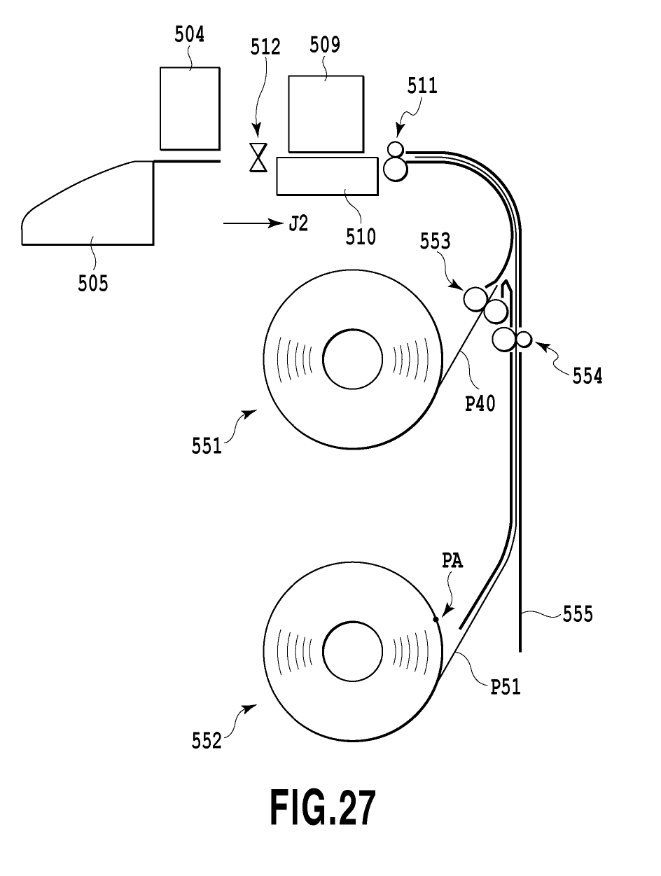

In the state in FIG. 27, the sheet P50 in the state in FIG. 26 is rewound to the second sheet supply unit 552 until the leading edge of the colorimetry sheet portion P51 has passed the upstream conveying roller pair 511. For the colorimetry sheet portion P51, PA represents a trailing edge position in the area where the color patches have been printed by the printing unit 509, i.e., the color patches have been printed in the area defined by the leading edge of the colorimetry sheet portion P51 to the trailing edge position PA. When the state in FIG. 26 is shifted to the state in FIG. 27, the second sheet supply unit 552 and the second feeding roller pair 554 are driven to convey the colorimetry sheet portion P51 in the direction indicated by the narrow J2. Then, when the state in FIG. 27 is established, rotation of the second sheet supply unit 552 is halted, and only the second feeding roller pair 554 is driven.

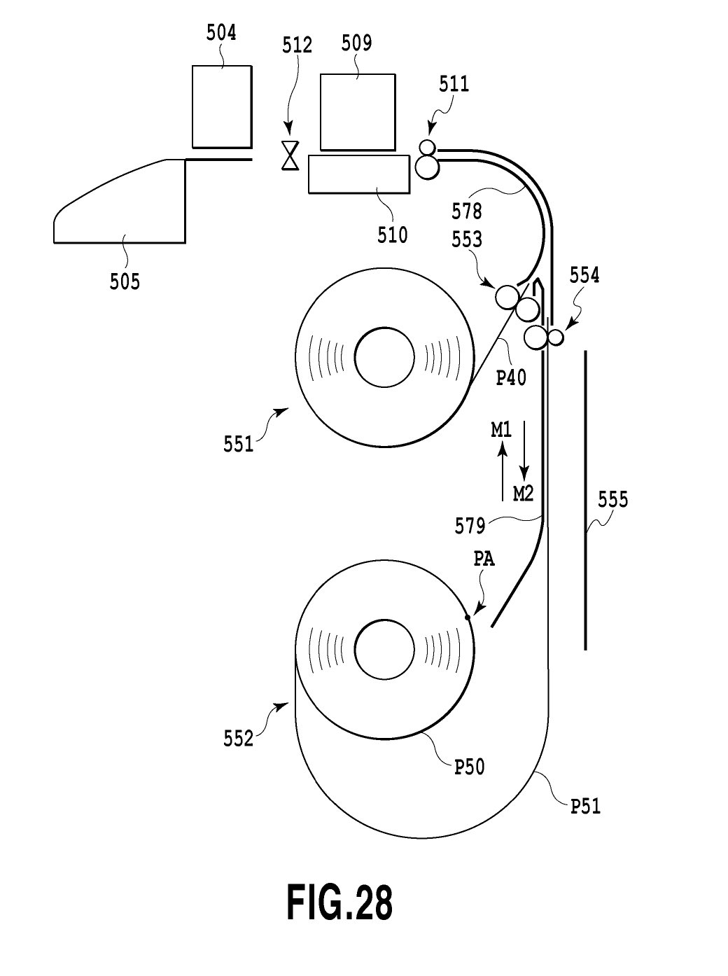

Specifically, when only driving of the second feeding roller pair 554 is continued after the state in FIG. 27 has been established, the colorimetry sheet portion P51 sags down below the second sheet supply unit 552 as shown in FIG. 28. In the state in FIG. 28, when the sheet P50 is rewound until the leading edge of the colorimetry sheet portion P51 has reached the position slightly downward of the second feeding roller pair 554 in a direction indicated by an arrow M1, the driving of the second feeding roller pair 554 is halted. Further, when the second feeding roller pair 554 is halted, the conveyance guide 555 is moved in a direction at a distance from the conveyance path 579. In the state shown in FIG. 27, the area of the colorimetry sheet portion P51 where the color patches are printed is efficiently dried, without contacting the reverse side (the non-printed face) of the colorimetry sheet portion P51 or the conveyance guide 555. Before the color patch bearing face of the colorimetry sheet portion 51 is passed along the conveyance path 579 opposite the conveyance guide 555, the conveyance guide 555 may be moved in the direction at the distance from the conveyance path 579. In this case, since the color patch printed face will not contact the conveyance guide 555, the probability that the color patch printed face might be damaged can be removed.

In this embodiment, a first path is extended from the first sheet supply unit 551 via the conveyance path 578 and the printing unit 509 to the cutter 512, and a second path is formed of the conveyance paths 578 and 579. The conveyance path 579 is a different path from a conveyance path extended from the feeding roller pair 553 to the discharge portion 505. Therefore, during the drying period, the colorimetry sheet portion P51 does not adversely affect the printing of the sheet P40 that is fed from the first sheet supply unit 551. After a predetermined drying period has elapsed, the second feeding roller pair 554 and the upstream conveying roller pair 511 are reversely rotated, and the colorimetry sheet portion P51 that has been dried is conveyed in the direction indicated by the arrow J1. Thereafter, colorimetric measurement for the color patches is performed by the colorimetric measurement unit 504, and the colorimetry sheet portion P51 is cut off by the cutter 512 and is discharged externally from the discharge portion 505.

In this embodiment, the first and second sheet supply units 551 and 552 for feeding the roll sheets are arranged, and the partial portions of the conveyance paths 578 and 579 used for sheet feeding are employed to provide the second path used for drying the colorimetry sheet portion. Therefore, the second path may be prepared so as to partially include the conveyance paths (feeding paths) 578 and 579. Three or more sheet feeding paths may be formed, and the second path can be provided to include a part of at least one of paths used for feeding different sheets.

### Thirteenth Embodiment

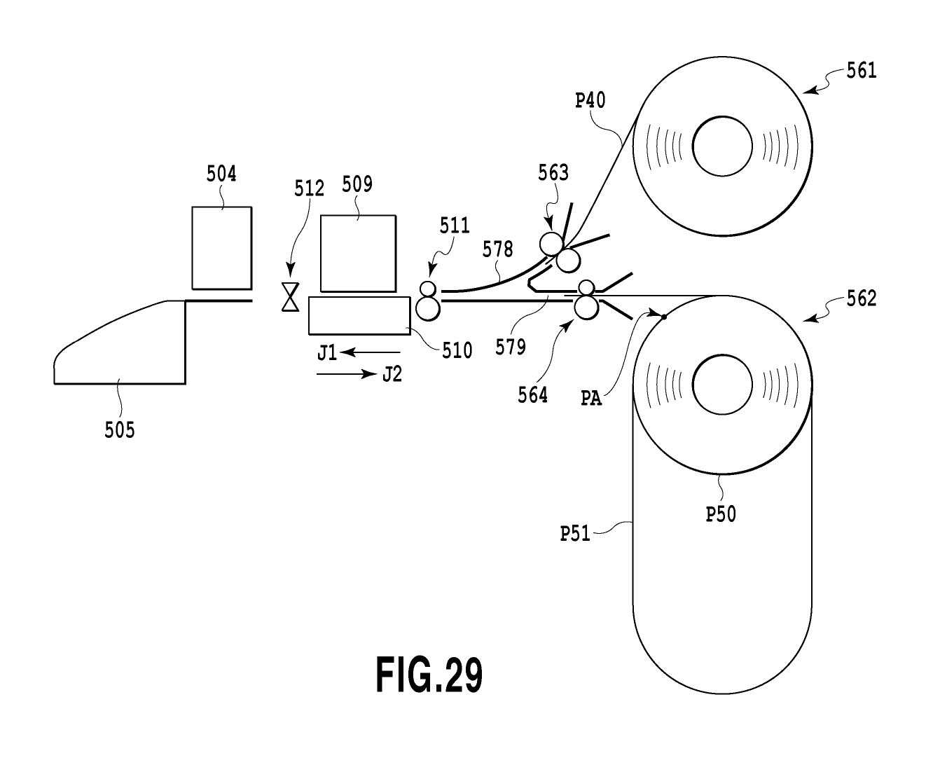

FIG. 29 is an explanatory diagram for a thirteenth embodiment of the present invention. Since the arrangement downstream of the upstream conveying roller pair 511 in the direction indicated by the arrow J1 is the same as that for the sixth embodiment, no further explanation for this portion will be given. In this embodiment, the colorimetry conveying roller pair 513 provided for the sixth embodiment are not employed.

A roll sheet P40 is set to a first sheet supply unit 561, and is to be fed by a first feeding roller pair 563 along a conveyance path 578. A roll sheet P50 is set to a second sheet supply unit 562, and is to be fed by a second feeding roller pair 564 along a conveyance path 579. The second feeding roller pair 564 can hold a colorimetry sheet portion where color patches used for colorimetric measurement are printed, which will be described later. As well as in the twelfth embodiment, for the colorimetry sheet portion P51, PA represents the trailing edge position in the area where the color patches are printed by the printing unit 509, i.e., the color patches are printed in the area defined by the leading edge of the colorimetry sheet portion P51 to the trailing edge position PA.

Similarly to the twelfth embodiment, when color patches used for colorimetric measurement have been printed by the printing unit 509 on the sheet P50 that has been fed, the second sheet supply unit 562 and the second feeding roller pair 564 are reversely rotated to rewind the sheet P50 in the direction indicated by the arrow J2. In the state shown in FIG. 29, the sheet P50 (colorimetry sheet portion P51) where the color patches have been printed is rewound until the leading edge of the colorimetry sheet portion P51 has reached the position slightly downstream of the second feeding roller pair 564 in the direction indicated by the arrow J1, and the driving of the second feeding roller pair 564 is halted.

In this embodiment, immediately before the trailing edge position PA of the color patch printed face of the colorimetry sheet portion P51 overlaps the non-printed face of the sheet P50, only the rotation of the second sheet supply unit 562 is halted, while the driving of the second feeding roller pair 564 is continued. As a result, as shown in FIG. 29, the colorimetry sheet portion P51 sags down below the second sheet supply unit 562. Further, when the colorimetry sheet portion P51 is rewound until the leading edge has reached the position slightly downstream of the second feeding roller pair 564 in the direction indicated by the arrow J1, the driving of the second feeding roller pair 564 is halted. In the state shown in FIG. 29, the area of the colorimetry sheet portion P51 where the color patches are printed is efficiently dried, without contacting the reverse side (non-printed face) of the colorimetry sheet portion P51.

In this embodiment, a first path is extended from the first sheet supply unit 561, via the conveyance path 578 and the printing unit 509, to the cutter 512. A second path is the conveyance path 579. The conveyance path 579 is a different path from a conveyance path extended from the feeding roller pair 563 to the discharge portion 505. Therefore, during the drying period, the colorimetry sheet portion P51 does not adversely affect the printing of the sheet P40 that is fed from the first sheet supply unit 561. After a predetermined drying period has elapsed, the second feeding roller pair 564 and the upstream conveying roller pair 511 are reversely rotated, and the colorimetry sheet portion P51 that has been dried is conveyed in the direction indicated by the arrow J1. Thereafter, colorimetric measurement for the color patches is performed by the colorimetric measurement unit 504, and the colorimetry sheet portion P51 is cut off by the cutter 512 and is externally discharged from the discharge portion 505.

For the sixth to the thirteenth embodiments, the colorimetry sheet or the colorimetry sheet portion that is held by the support roller pair is conveyed to the colorimetric measurement unit after the drying period designated in advance has elapsed. However, when the environment (temperature/humidity) where the printing apparatus is installed is detected, and the drying period is automatically set in accordance with the environmental conditions, more efficient drying can be performed. Further, the optimal drying period of time can also be designated in accordance with the type of sheet used as a printing medium, the type of ink and the printing contents (including the printing density). Furthermore, when forced drying of the colorimetry sheet or the colorimetry sheet portion is performed by blowing air or applying heat, the drying time can be reduced, and accordingly, the throughput can be improved.

For all of the embodiments described above, the basic arrangement for the printing apparatus includes: the printing unit for printing an image on the sheet conveyed along the first path; the second path to which the sheet can be moved from the first path; and the colorimetric measurement unit for performing colorimetric measurement of the sheet on which the image has been printed. The second path is prepared in order to provide a location where the sheet printed by the printing unit can wait. As the characteristic element of this embodiment, in the state wherein the sheet moved to the second path is waiting for the colorimetric measurement of the sheet to be performed by the colorimetric measurement unit, or in the state wherein while colorimetric measurement of the sheet is being performed by the colorimetric measurement unit, image printing for another sheet can be performed by the printing unit using the first path. More specifically, printing of the normal image can be performed concurrently while the sheet for the colorimetric measurement is being held, or the colorimetric measurement is being performed. Therefore, the user does not have to wait an extended period of time for the start of the primary printing operation, and for printing, the productivity and usability are greatly improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-257085, filed Nov. 25, 2011, which is hereby incorporated by reference herein in its entirety.

What is claimed is:

1. A printing apparatus comprising:
a first path;
a printing unit configured to print an image, including a color pattern for colorimetric measurement, on a sheet conveyed along the first path;
a second path configured to be able to receive the sheet from the first path, and to hold the sheet on which the image has been printed by the printing unit;
a colorimetric measurement unit configured to perform colorimetric measurement of the color pattern,
wherein (a) after a sheet with the color pattern is received in the second path and before the colorimetric measurement unit performs colorimetric measurement or (b) while the colorimetric measurement unit performs colorimetric measurement, the printing unit is able to print an image on a sheet other than the sheet with the color pattern.

2. The printing apparatus according to claim 1, wherein the colorimetric measurement unit performs colorimetric measurement at a measurement position where a sheet with the color pattern is passed after the sheet is held by the second path and conveyed again.

3. The printing apparatus according to claim 2, wherein a print position whereat the printing unit performs printing is located along the first path, and
wherein the measurement position is located in either the first path or the second path.

4. The printing apparatus according to claim 1, further comprising:
a first discharge portion configured to discharge the sheet on which the image has been printed by the printing unit and for which colorimetric measurement is not performed by the colorimetric measurement unit; and
a second discharge portion, different from the first discharge portion, configured to discharge the sheet on which the color pattern has been printed by the printing unit and for which colorimetric measurement has been performed by the colorimetric measurement unit.

5. The printing apparatus according to claim 1, further comprising:
a discharge portion employed in common for discharging both the sheet on which the image is printed by the printing unit and for which colorimetric measurement is not performed by the colorimetric measurement unit, and the sheet on which the color pattern has been printed by the printing unit and for which colorimetric measurement has been performed by the colorimetric measurement unit.

6. The printing apparatus according to claim 1, further comprising:
a switching unit configured to switch a sheet conveyance direction between a direction toward the first path and a direction toward the second path, the switching unit is arranged at a branch section between the first path and the second path.

7. The printing apparatus according to claim 1,
wherein the printing unit is located downstream of the colorimetric measurement unit;
wherein while a sheet is being conveyed along the first path, on which the color pattern is printed by the printing unit, the sheet is thereafter conveyed upstream, and is received from the first path in the second path, and sequentially, the sheet which has been held along the second path is conveyed downstream, and for the sheet colorimetric measurement is performed by the colorimetric measurement unit.

8. The printing apparatus according to claim 1,
wherein the printing unit is located upstream of the colorimetric measurement unit;
wherein while a sheet is being conveyed along the first path, on which the color pattern is printed by the printing unit, the sheet is thereafter conveyed downstream, and is received from the first path in the second path, and sequentially, the sheet which has been held along the second path is conveyed upstream, and for the sheet colorimetric measurement is performed by the colorimetric measurement unit.

9. The printing apparatus according to claim 1,
wherein the printing unit is located downstream of the colorimetric measurement unit;
wherein while a sheet is being conveyed along the first path, on which the color pattern is printed by the printing unit, the sheet is thereafter conveyed upstream, and is received from the first path in the second path, and sequentially, the sheet which has been held along the second path is conveyed upstream, and for the sheet colorimetric measurement is performed by the colorimetric measurement unit.

10. The printing apparatus according to claim 1, wherein a member is provided in the second path, the member being capable of holding the sheet by gripping a part of the sheet that has been received in the second path, and capable of suspending the sheet.

11. The printing apparatus according to claim 1, further comprising:
a supply unit configured to feed the sheet, to be printed by the printing unit, to the first path; and
a cutter configured to cut the sheet at place near the printing unit.

12. The printing apparatus according to claim 11, wherein the supply unit is to support a plurality of rolled sheets or cut sheets, and is capable of feeding either the rolled sheets or the cut sheets to the first path.

13. A colorimetric measurement apparatus, incorporated in a printing apparatus that includes a printing unit that prints an image on a sheet being conveyed along a first path, the apparatus comprising:
a member serving as a second path, in which the sheet can be received from the first path and along which the sheet on which the image is printed by the printing unit is retained; and
a colorimetric measurement unit, for performing colorimetric measurement of the sheet,
wherein the member and the colorimetric measurement unit are integrally formed as a single unit, and the unit is detachably mounted on the printing apparatus.

14. A printing method, for an apparatus that includes a printing unit and a reading unit, comprising the steps of:
printing of an image on a first sheet by the printing unit;
after printing, holding the first sheet in a waiting state in the apparatus;
after waiting, reading of the image on the first sheet by the reading unit; and
while the first sheet is being held, or while the image is being read by the reading unit, conveying a second sheet, different from the first sheet, to the printing unit without interfering with the first sheet, and printing an image on the second sheet.

15. The printing method according to claim 14, further comprising a step of:
discharging the first sheet, that has been read, to a discharge portion that differs from a discharge portion to which the second sheet is discharged.
